(19) United States
(12) Patent Application Publication
(10) Pub. No.: US 2006/0104295 A1
(43) Pub. Date: May 18, 2006

(54) Queued, asynchronous communication architecture interface

(75) Inventors: John S. Worley, Fort Collins, CO (US); William S. Worley JR., Centennial, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: SECURE64 SOFTWARE CORPORATION, Greenwood Village, CO (US)

(21) Appl. No.: 11/281,838

(22) Filed: Nov. 16, 2005

Related U.S. Application Data
(60) Provisional application No. 60/628,650, filed on Nov. 16, 2004.

(51) Int. Cl. H04L 12/56

(52) U.S. Cl. 370/401; 370/465

(57) ABSTRACT

Methods and techniques are provided for implementing a queued, asynchronous application programming interface (API) for network communications. According to one embodiment, the API provides (i) a system abstraction representing a connection between a local machine and a remote machine, and (ii) multiple routines accessible to applications for operating on connections. The connections instantiated by applications based upon the system abstraction are capable of providing full duplex communication channels between their respective local machines and remote machines. The routines define operations and parameters to establish, accept, read, write and close the connections.

This application claims the benefit of U.S. Provisional Application No. 60/628,650 filed Nov. 16, 2004, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright 2004-2005, Secure64 Software Corporation.

### BACKGROUND

1. Field

Embodiments of the present invention generally relate to methods and interfaces for providing asynchronous input/output (I/O) among devices. More particularly, embodiments of the present invention relate to a queued, asynchronous application programming interface (API) for network communications.

2. Description and Shortcomings of the Related Art

The 20-year old Berkeley sockets interface (see, e.g., Wright and Stevens, TCP/IP Illustrated Volume 2, Addison Wesley (1996); ISBN 0-201-63354-X, Ch. 16 and Ch. 17) is a tried and true, venerable interface that has proved itself repeatedly. However, the communication paradigm used by sockets introduces delays, overhead, scheduling problems, and does not scale for multiprocessing.

Sockets were a very reasonable and relatively modest addition to the UNIX system, which lacked, and still lacks, a standard method for true asynchronous (as opposed to non-blocking) input/output (I/O). Further, the only I/O abstraction available in UNIX is the file, which is, in many ways, poorly suited to the needs of network communications. Without a major re-architecting of the operating system, alternative solutions were not feasible at the time sockets were introduced.

Performance Problem #1: Overhead

FIG. 1 illustrates a typical prior art sequence of events 100 under the Berkeley sockets interface model. According to this example, an application 150 issues a select( ) call 105 to a Berkeley Software Design (BSD) socket interface 160 with one or more members of a file descriptor set (not shown) initialized to wait for events on one or more file descriptors. When the select( ) call 105 returns (READY 110), the application 150 linearly searches the returned list of available file descriptors (not shown). The data associated with the event, e.g., read data available 120, is read by issuing a read( ) system call 115 to the BSD socket interface 160 or written with a system call (usually set non-blocking). The data 120 is processed, if necessary, by the application 150. If the application 150 has further interest in the socket, it inserts the file descriptor into the file descriptor set. The application 150 may then repeat this process.

Referring now to the time line of this sequence of events 100, the times corresponding to B, C, and E represent the overhead of the BSD socket interface 160. By far the largest component is C, but the cost of setting up for and interpreting the results of select( ) call 105 (i.e., the portions marked B and E) cannot be ignored. Note that it doesn't matter whether the file descriptors are processed serially, or are collected from the select( ) results and then processed serially: the overhead is effectively the same because the C overhead is incurred for every request.

For networking offload cards, the overhead is substantially increased because the network data no longer resides in the I/O buffers of a general-purpose operating system, but rather in the memory of the card, which operates asynchronously with the system. Even when the command is issued to the card, there will be large latencies before the request will even be processed, the latency of the direct memory access (DMA), and the latency of the acknowledgement. Under the BSD socket interface 160, this is a built-in bottleneck that severely limits performance.

Performance Problem #2: Scheduling

Another limitation of the BSD socket interface 160 is one of scheduling. The select( ) call 105 does not preserve any temporal information in the file descriptors; conceptually, they are all ready at the same time, even if one event happened much earlier and notification was delayed due to scheduling or other system activity. This places the burden of scheduling processing on the application 150, which must rely on hopeful heuristics and approximations to give fair service to all connections.

Performance Problem #3: Multiprocessing (MP)

A further problem with the BSD socket interface 160 is that it does not adapt well to nor scale well in a multiprocessing environment. Clearly, it would be a performance disaster for one processor to handle select( ) calls for all active connections, yet distributing the connections is an intractable problem. The application 150 cannot know a priori which descriptors will be ready first, almost ensuring that the processing will be unbalanced, wasting cycles on some processors while connections are gridlocked on others. Problems of serialization, starvation, and resource waste are difficult to manage, and pathological cases will arise, almost certainly when performance is needed most.

Performance Problem #4: Off-Load Processors

The structure of BSD socket interface 160 internals reflects the classic network protocol stack. Under this sockets interface model, network routing decisions are performed at the lowest level of the protocol, e.g., the Internet Protocol (IP) layer in Transmission Control Protocol (TCP)/IP. This design does not easily adapt to protocol off-load processors, since the decision to direct the data stream needs to be made much earlier, usually at the top of the stack. On the input side, the data stream must somehow circumvent the existing protocol, since it has already been processed.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 illustrates a typical prior art sequence of events under the Berkeley sockets interface model.

FIG. 2 is an example of a computer system with which embodiments of the present invention may be utilized.

FIG. 3A conceptually illustrates a computer system configured to provide secure server functionality according to one embodiment of the present invention in which a SGPOS retains control of a partition of system resources.

FIG. 3B conceptually illustrates a computer system configured to provide secure server functionality according to an alternative embodiment of the present invention in which a SGPOS is placed in a dormant state and surrenders complete control of system resources to a CE².

FIG. 4 conceptually illustrates an architecture to support one or more guest operating systems according to one embodiment of the present invention.

FIG. 5 is a data flow and control flow diagram illustrating the operation of an asynchronous network I/O stack according to one embodiment of the present invention.

### SUMMARY

Methods and techniques for implementing a queued, asynchronous application programming interface (API) for network communications are described. According to one embodiment, the API provides (i) a system abstraction representing a connection between a local machine and a remote machine, and (ii) multiple routines accessible to applications for operating on connections. The connections instantiated by applications based upon the system abstraction are capable of providing full duplex communication channels between their respective local machines and remote machines. The routines define operations and parameters to establish, accept, read, write and close the connections.

Other features of embodiments of the present invention will be apparent from the accompanying drawings and from the detailed description that follows.

### DETAILED DESCRIPTION

Methods and techniques for implementing a queued, asynchronous application programming interface (API) for network communications are described. According to various embodiments of the present invention, a qNet connection API is provided as part of a set of system services implemented within a custom execution environment (CE²) that is designed to address one or more of the inherent problems associated with sockets. For example, in one embodiment, connections are provided as a first class system abstraction, rather than just semantics layered on another abstraction. The qNet connection API design also seeks to minimize the number of steps needed to establish, use, and close connections.

According to one embodiment, on the system side of the implementation, the design allows for the easy addition of new interfaces and protocols, and allows for the efficient use of off-load processors. In fact, in one embodiment, all interfaces are abstracted as off-load processors, even those whose code runs natively.

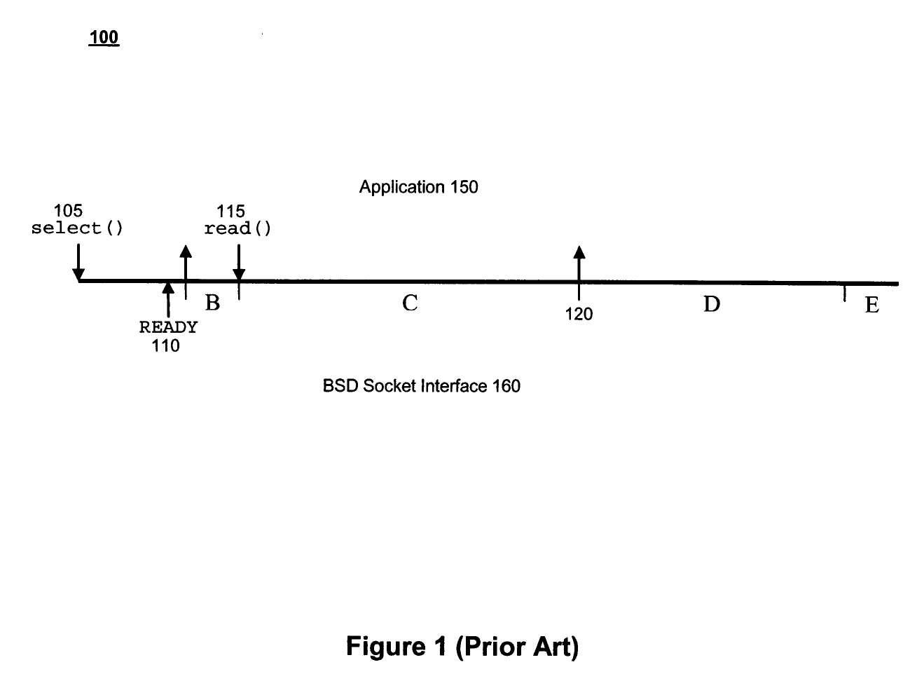

According to one embodiment, in order to enhance application performance, all qNet connection API calls are non-blocking, thereby allowing the code to make forward process as much as possible. There are at least three consequences of non-blocking calls that are worthy of discussion:
First, all connection activity is asynchronous. As should be understood with reference to FIG. 1, asynchronous I/O removes a large amount of overhead from the processing, since the connection isn't otherwise considered ready until the data transfer is complete. For best performance, the asynchronous requirement should also apply to making and accepting connections. Unlike non-blocking connections, the asynchronous connections provided for by embodiments described herein allow an application to queue one or more I/O operations as soon as the underlying structures are initialized. Therefore, the application need not wait for connection establishment to be completed before commencing I/O operations.
Preferably, an application would be interrupted when the asynchronous operations have completed. However, many applications are not structured to handle asynchronous event notification, so synchronous methods are also provided by embodiments of the present invention. In one embodiment, in both modes of operation, completions are always reported in completion order.
Since requests complete asynchronously, it is useful to allow the application to associate an arbitrary opaque parameter with each request that will be returned by the system when the result status is presented. This value can represent any information the application requires.

By structuring a communications architecture around one or more of these and other design points, qNet was developed. The name is intended to emphasize the queued, asynchronous nature of the interface, which reflects the queued, asynchronous nature of modern network communication.

In the following description, for the purposes of explanation, numerous specific details, including code and data structure examples, are set forth in order to provide a thorough understanding of embodiments of the present invention. It will be apparent, however, to one skilled in the art that embodiments of the present invention may be practiced without some of these specific details and that the present invention is not intended to be limited to the specific examples provided. In other instances, well-known structures and devices are shown in block diagram form.

Embodiments of the present invention include various steps, which will be described below. The steps may be performed by operator configuration, hardware components, or may be embodied in machine-executable instructions, which may be used to cause a general-purpose or special-purpose processor programmed with the instructions to perform the steps. Alternatively, the steps may be performed by a combination of operator configuration, hardware, software, and/or firmware.

Embodiments of the present invention may be provided as a computer program product, which may include a machine-readable medium having stored thereon instructions that may be used to program a computer (or other electronic devices) to perform a process. The machine-readable medium may include, but is not limited to, magnetic disks, floppy diskettes, optical disks, compact disc read-only memories (CD-ROMs, CD-Rs, CD-RWs), digital versatile disks (DVD-ROM, DVD+RW), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to a connection API for network communications provided in the context of a customized execution environment, the present invention is equally applicable to various other environments. For example, the qNet connection API may be incorporated into an operating system, such as one or more of the principal general-purpose operating systems, i.e., current or future versions of the UNIX, Linux and/or Windows operating systems, or a specialized operating system.

In addition, for sake of brevity, embodiments of the present invention are described with reference to TCP and User Datagram Protocol (UDP). Nevertheless, the present invention is equally applicable to various other communication protocols and web protocols. Furthermore, while intended to serve as a replacement for sockets in the context of network communications, the qNet connection API may coexist with sockets. Finally, for purposes of facilitating software development and testing, the qNet connection API can be emulated on top of sockets.

Terminology

Brief definitions of various terms, abbreviations, and phrases used throughout this application are given below.

The term “completion,” when used with reference to a request, generally refers to a request that has terminated, with or without an error condition. Completions are queued internally and are accessed by an application through one or more appropriate qNet connection API calls.

The phrase “concurrent customized execution environment” or the abbreviation “C²E²” generally refers to a customized execution environment that coexists with a general-purpose operating system and shares at least a means of communication with the general-purpose operating system.

The terms “connected” or “coupled” and related terms are used in an operational sense and are not necessarily limited to a direct physical connection or coupling.

The term “connection” generally refers to a system abstraction corresponding to a full duplex communication channel between a local machine and a remote machine.

The phrase “customized execution environment” or “CE²” generally refers to a customized operating environment itself, in which there is provided a set of system services implemented in software having direct access and full control over a portion of system resources. An example of a CE² is described in co-pending US Pat. App. Pub. No. 20040177243, which is hereby incorporated by referenced for all purposes. CE²s are quite distinct from an operating system or specialized operating system and depending upon the particular embodiment may include one or more of the following features:
1. A CE² may comprise both statically linked system code and data modules and application code and data modules;
2. A CE² may lack the capability to load or to load and execute any other application;
3. The functional capabilities of a CE² may be strictly limited only to those services required by a particular application or small set of applications;
4. A CE² typically falls far short of the capabilities expected of an operating system; specifically, in one embodiment, applications are limited to a single thread of execution in each processor or core of a multicore processor controlled by the CE²;
5. The services interfaces of a CE² may be simple and specialized for each of one or a small set of particular applications, rather than being comprised by a more complex and general API for a broad class of applications;
6. Management strategies for system resources within a CE² sometimes differ entirely from those strategies adopted by traditional general-purpose operating systems;
7. A CE² may utilize hardware capabilities not supported by a general-purpose or symbiotic general-purpose operating system;
8. A CE² may make substantial use of hardware capabilities not well utilized by a general-purpose or symbiotic general-purpose operating system; and
9. The services provided to the application within a CE² may be designed to enable an application far more easily to recover and continue from a system error.
10. According to one embodiment of the present invention, a general-purpose operating system at least temporarily relinquishes control of all or a portion of system resources associated with a computer system to one or more CE²S. According to another embodiment, a CE² may be booted on hardware directly. For example, a general-purpose operating system may launch a CE² without ever taking control over the portion of system resources to be controlled by the CE². In still another embodiment, both the general-purpose operating system and one or more CE²s may be booted into distinct hardware partitions such as those provided in the Hewlett Packard Superdome platform. CE²s are typically specialized for a particular hardware platform. According to one embodiment, a CE² is non-portable and there are no general-purpose operating system abstractions interposed between the customized execution environment and the system resources allocated to the customized execution environment. Typically, system services provided by a CE² will implement a simplified computational structure and/or an I/O structure that are tuned for a particular application. For example, a CE² may take advantage of certain processor or other system resource features that are not exploited by the general-purpose operating system. According to one embodiment, a tuned CE² is provided to support a web edge engine, such as a web server, secure web server, proxy server, secure proxy server or other application or communication servers, to allow the web edge engine to drive the utilization of network connections as close as possible to 100%.

The phrase “delivery service” generally refers to a specific protocol family (e.g., IPV4 or IPV6) on a specific physical connection.

The term “handle” generally refers to an identifier associated with a specific connection. According to one embodiment, a handle comprises a 32-bit token that identifies a specific connection.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The term “incoming,” when used with reference to a connection, generally refers to a connection initiated from a remote machine to a protocol-specific endpoint on the local machine.

The abbreviation “IPV4” generally refers to the suite of network protocols based on the Internet Protocol, Version 4.

The abbreviation “IPV6” generally refers to the suite of network protocols based on the Internet Protocol, Version 6.

If the specification states a component or feature “may”, “can”, “could”, or “might” be included or have a characteristic, that particular component or feature is not required to be included or have the characteristic.

The phrase “offload board” generally refers to a separate plug-in board, such as a separate plug-in board that may support higher level interfaces and employ additional processing cycles to deal with higher volume network or other processing loads. In one embodiment, such a board may be employed solely to assist in securely booting.

The phrase “opaque parameter” generally refers to information generated by an application and supplied by the application as part of a qNet connection API request that helps the application identify the specific request. In one embodiment of the present invention, the qNet connection API returns the application-supplied opaque parameter with the result block upon completion of the corresponding request. The opaque parameter may be encoded in any manner the application chooses to identify the specific request. For example, the opaque parameter may be a 64-, 32- or 16-bit value, a pointer to an array, an integer value a table index, one or more flags, an address of a completion function, an address of a control structure, a pointer to a data structure, an index into a data structure, a pointer to a function, a bit mask, a combination of codes and bit masks, multiple smaller fields, etc.

The term “outgoing,” when used with reference to a connection, generally refers to a connection initiated from the local machine to a specific remote machine. The remote machine is typically identified by either protocol address or domain name, plus protocol-specific information, e.g., a UDP or a TCP port.

The phrase “Parallel Protected Architecture” or “PPA” generally refers to a computer architecture that includes at least the explicit instruction level parallelism and protection capabilities of the Itanium 2 processors.

The term “pending,” when used with reference to a request, generally refers to a request that has not yet terminated. According to one embodiment, a connection subject to a pending connection request, either incoming or outgoing, may accept read and/or write requests before the actual network connection is complete.

The phrases “principal general-purpose operating systems” or “ULW systems” generally refers to current and future versions of the UNIX, Linux, and Windows operating systems.

The term “request” or the phrase “request block” generally refer to an operation and associated parameters relating to a connection. According to one embodiment, operations on a connection include making, accepting, reading, writing, and/or closing the connection. In one embodiment, all requests are asynchronous, i.e., the system code validates parameters, queues the operation, but does not wait for completion before returning to the caller.

The term “responsive” includes completely or partially responsive.

The term “result” or the phrase “result block” generally refer to the values associated with a completion. According to one embodiment, these values are available when the application is notified, whether synchronously or asynchronously. These parameters may include the connection's handle, remote IP and port addresses, completion status, and/or an opaque parameter that was included by the calling application with the request.

The phrase “symbiotic general-purpose operating system” or the abbreviation “SGPOS” generally refers to an operating system, such as one of the principal general-purpose operating systems, which has been enhanced to include one or more of the following capabilities: (1) a mechanism to manage the resources of a computer system in cooperative partnership with one or more CE²s; (2) a mechanism to partition/compartmentalize system resources and transfer control of one or more partitions of system resources, including processors, physical memory, storage devices, virtual memory identifier values, I/O devices, and/or exception delivery, to one or more CE²s; and (3) a mechanism to allow communications between partitions of systems resources. SGPOSs might remain portable or could become specialized for a particular hardware platform. An example of a SGPOS is described in co-pending US Pat. App. Pub. No. 20040177342, which is hereby incorporated by referenced for all purposes.

The phrase “system resources” generally refers, individually or collectively, to computational resources and/or other resources of a computer system, such as processors, physical memory, storage devices, virtual memory identifier values, input/output (I/O) devices, exception delivery and the like.

The term “thread” or the phrase “thread of execution” generally refer to the execution of successive instructions within a particular state of processor control registers. When a processor is executing two applications concurrently, it actually executes briefly in one application thread, then switches to and executes briefly in another application thread, back and forth.

The phrases “web engine” and “web edge engine” generally refer to hardware, firmware and/or software that support one or more web protocols.

The phrase “web protocols” generally refers to current and future networking protocols, including, but not limited to HyperText Transfer Protocol (HTTP), Secure HTTP (S-HTTP), Secure Sockets Layer (SSL), Transport Control Protocol (TCP), User Datagram Protocol (UDP), Internet Protocol (IP), Transport Layer Security (TLS), Extensible Markup Language (XML), Simple Object Access Protocol (SOAP), Universal Description, Discovery, and Integration (UDDI), DHTTP, HTTP/NG, File Transfer Protocol (FTP), Trivial File Transfer Protocol (TFTP), Common Open Policy Service (COPS), Flow Attribute Notification Protocol (FANP), Finger User Information Protocol, Internet Message Access Protocol rev 4 (IMAP4), IP Device Control (IPCD), Internet Message Access Protocol version 4rev1 (ISAKMP), Network Time Protocol (NTP), Post Office Protocol version 3 (POP3), Radius, Remote Login (RLOGIN), Real-time Streaming Protocol (RTSP), Stream Control Transmission Protocol (SCTP), Service Location Protocol (SLP), SMTP—Simple Mail Transfer Protocol (SMTP), Simple Network Management Protocol (SNMP), SOCKS, TACACS+, TELNET, and Web Cache Coordination Protocol (WCCP).

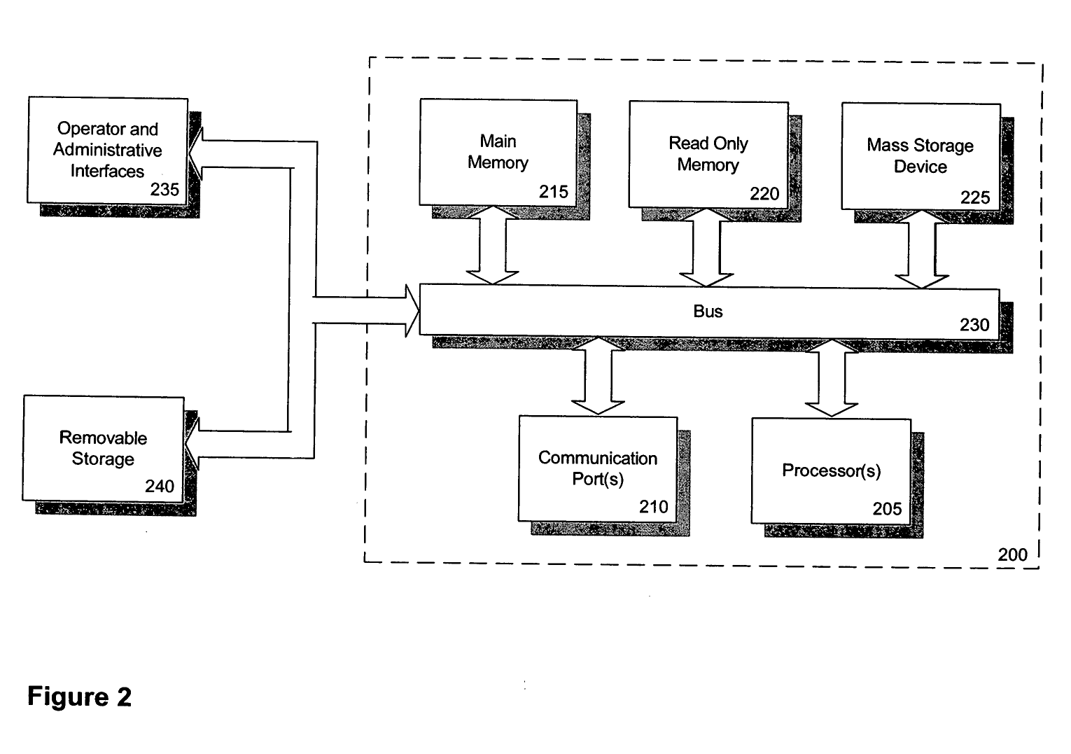

An exemplary computer system 200, representing an exemplary server, such as a 2-way HP Server rx1600, a 4-way HP Server rx5670, an HP Server rx2600, or the like, with which various features of the present invention may be utilized, will now be described with reference to FIG. 2. In this simplified example, the computer system 200 comprises a bus 230 or other communication means for communicating data and control information, and one or more processors 205, such as Intel® Itanium® or Itanium 2 processors, coupled with bus 230.

Computer system 200 further comprises a random access memory (RAM) or other dynamic storage device (referred to as main memory 215), coupled to bus 230 for storing information and instructions to be executed by processor(s) 205. Main memory 215 also may be used for storing temporary variables or other intermediate information during execution of instructions by processor(s) 215. According to various embodiments of the present invention, main memory 215 may be partitioned via a region-identifier-based memory partitioning mechanism. The resulting partitions may be assigned to one or more processors or one or more cores of a multi-core processor for exclusive access by such processors or cores using a hardware-based isolation mechanism, such as associating areas of memory with protection keys.

Computer system 200 also comprises a read only memory (ROM) 220 and/or other static storage device coupled to bus 230 for storing static information, such as cryptographic digital signatures associated with initial code and data images of one or more CE²s, customized applications, and operating system, and instructions for processor(s) 205.

A mass storage device 225, such as a magnetic disk or optical disc and its corresponding drive, may also be coupled to bus 230 for storing information and instructions, such as an operating system loader, an operating system, one or more customized applications and associated CE²s, initialization files, etc.

One or more communication ports 210 may also be coupled to bus 230 for supporting network connections and communication of information to/from the computer system 200 by way of a Local Area Network (LAN), Wide Area Network (WAN), the Internet, or the public switched telephone network (PSTN), for example. The communication ports 210 may include various combinations of well-known interfaces, such as one or more modems to provide dial up capability, one or more 10/100 Ethernet ports, one or more Gigabit Ethernet ports (fiber and/or copper), one or more network protocol offload boards, or other well-known network interfaces commonly used in internetwork environments. In any event, in this manner, the computer system 200 may be coupled to a number of other network devices, clients, and/or servers via a conventional network infrastructure, such as an enterprise's Intranet and/or the Internet, for example.

Optionally, operator and administrative interfaces 235, such as a display, keyboard, and a cursor control device, may also be coupled to bus 230 to support direct operator interaction with computer system 200. Other operator and administrative interfaces can be provided through network connections connected through communication ports 210.

Finally, removable storage media 240, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 230 via corresponding drives, ports or slots.

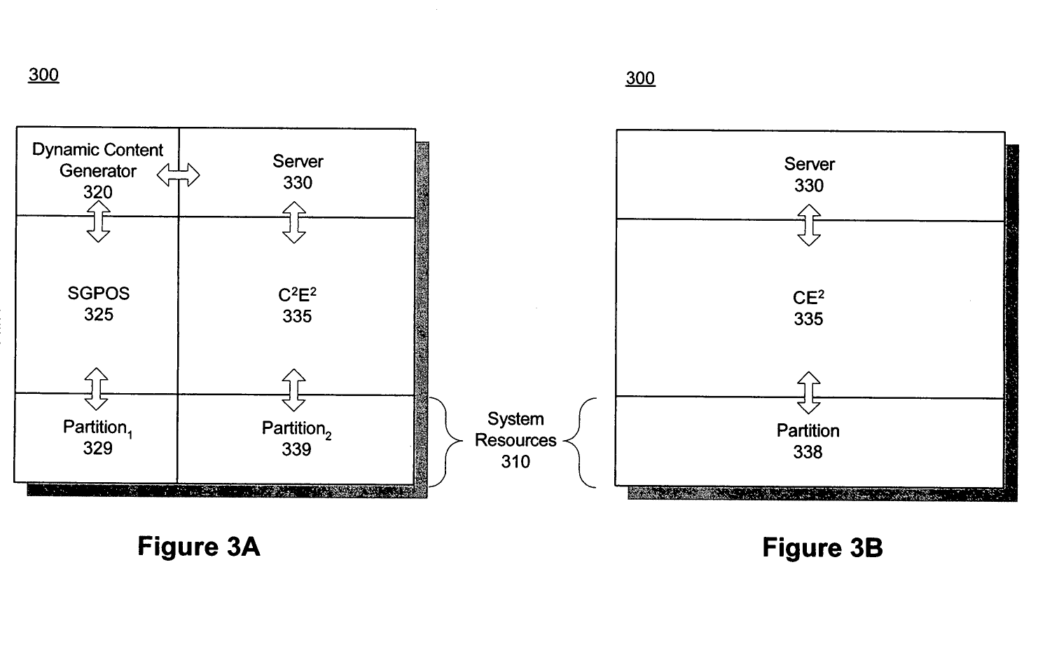

FIG. 3A conceptually illustrates a computer system 300 configured to provide a secure high-performance processing environment for a server 330 according to one embodiment of the present invention in which the SGPOS 325 retains control of a partition 329 of system resources. The system configuration depicted is illustrative of an exemplary multi-partition configuration that is supported by the existence of appropriate hardware-based isolation features in the processor, associated chipset or an intermediate interface, such as a secure-platform interface, interposed between the operating environments (e.g., the operating system and CE²(s)) and the system resources. Until such isolation features are widely available, platform hardware partitioning or a more typical single-partition configuration, such as that illustrated in FIG. 3B, is expected to be the configuration of choice for secure systems.

At any rate, returning to the present example, the computer system 300 is conceptually illustrated after allocation of its system resources 310 between partition 329 associated with SGPOS 325 which provides services to a dynamic content generator 320, and partition 339 associated with CE² 335, which provides services to a secure server 330. Because the CE² 335 is not limited to the portability constraints imposed on the SGPOS 325 and general-purpose operating systems as a whole, it can implement a computational and/or I/O structure that are simplified and optimized for the particular underlying hardware platform (e.g., one or more Intel Itanium 2 processors and associated chipsets) and/or a particular customized application (e.g., a secure proxy server or a secure server 330).

The present example illustrates one possible system configuration, which when employing future hardware isolation capabilities or current hardware platform partitioning, allows server security and performance to be enhanced while maintaining the ability to run other customer applications by supporting the concurrent and cooperative execution of a resident operating system, the SGPOS 325, and an operating environment, the CE² 335, that is separate from the resident operating system.

FIG. 3B conceptually illustrates a computer system 300 configured to provide a secure high-performance processing environment for a server 330 according to an alternative embodiment of the present invention. The system configuration depicted is illustrative of a possible system configuration in which the resident operating system, after initializing and launching the CE² 335, surrenders complete control of all or substantially all of the system resources 311 to the CE² 335 and is then placed in a dormant state from which it can be revived upon release of the system resources 311 by the CE² 335. Either hardware platform partitioning or a system configuration in which the SGPOS 325 is quiesced and full control of all or substantially all of the system resources 311 is placed in one or more CE²s, are expected to be the predominate configurations until the anticipated hardware-based isolation features are both available and achieve industry acceptance. To the extent isolation is desirable within and/or between CE² partitions, current or future advanced memory protection architectures, such as region identifiers, protection identifiers, and memory page access rights, may be used.

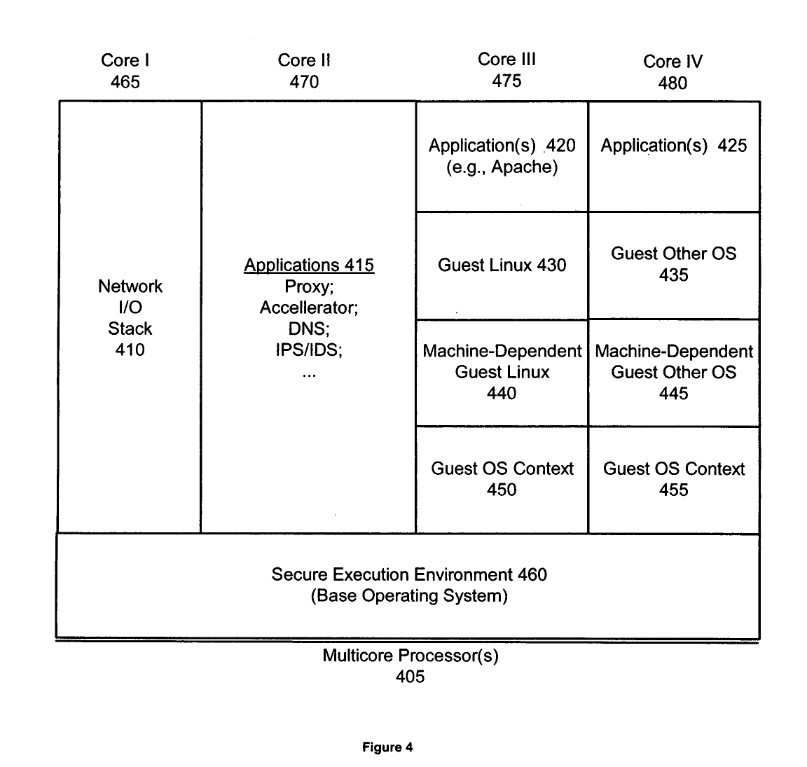

FIG. 4 conceptually illustrates an architecture to support one or more guest operating systems according to one embodiment of the present invention. In the example depicted, a guest operating system context (GOSC) 450, 455 is interposed between a base operating system in the form of a CE² (i.e., secure execution environment 460) and a machine-dependent guest operating system (i.e., machine-depending guest Linux 440 and machine-dependent guest other OS 445, respectively) to provide an interface between the guest OS, e.g., Linux, and the secure execution environment 460, which controls the actual hardware platform.

In one embodiment, the guest OS context 450, 455 provides and expands upon functionality of a typical virtual machine control program, now commonly called a “Virtual Machine Monitor” (VMM). This enables applications 420, 425 to use APIs not present in the guest operating systems (e.g., guest Linux 430 and guest other OS 435), without having to make and standardize extensions to a mainline general-purpose operating system. In the embodiment depicted, it also permits separate cores of multicore processor(s) 405 to perform work on behalf of the applications within the guest operating system without having to deal with the multi-processor complexities and overheads within the guest operating system.

In general, access to tuned functions executing upon both the same core and upon other cores can be provided. For example, in the case of network I/O stack 410, a separate core may function as a network offload component. As described further below, in one embodiment, the network I/O stack 410 may be fully asynchronous and driven by a queued API, which may be referred to herein as the qNet connection API. In this manner, applications 420, 425 originally developed for and executing in guest operating systems, such as Linux, may take advantage of the performance and advantages of the network I/O stack 410.

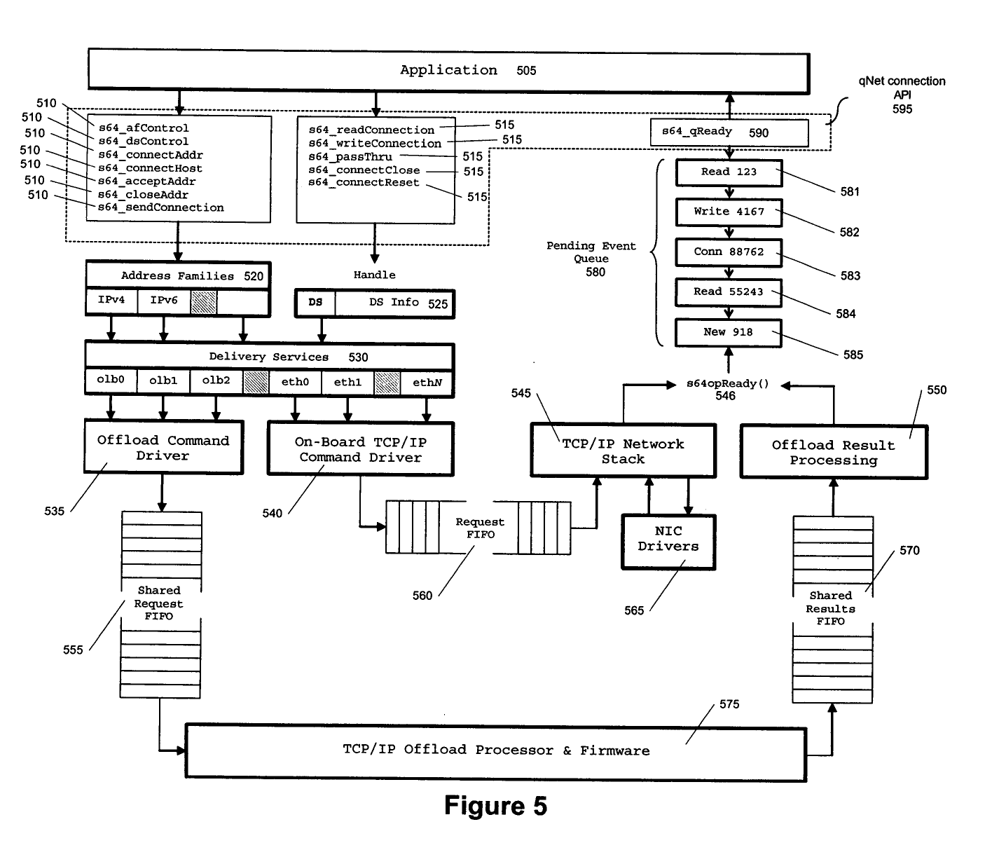

FIG. 5 is a data flow and control flow diagram illustrating the operation of an asynchronous network I/O stack according to one embodiment of the present invention. In the present example, an application 505 is executing within a guest operating system or to the native application interface (i.e., the CE² API). The application 505 establishes and uses connections by making calls to a qNet connection API 595. Each call by the application 505 to the qNet connection API 595 specifies one of the defined request blocks 510, 515. According to one embodiment, each request block 510, 515 contains an opaque parameter that may be encoded in any manner the application 505 chooses to identify the specific request. When a corresponding result block is posted to the pending event queue 580, the opaque parameter is returned in the result block.

Request blocks 510 specify controls for accepting and establishing network connections. According to the present example, each request block 510 specifies an address family 520, such as IPv4 or IPv6.

Request blocks 515 specify data transfers and controls for reading, writing, closing and resetting network connections. These request blocks specify an already established connection using an identifying handle 525 supplied when the connection was first established.

Delivery services 530 enqueue request blocks for the specified on-board or offload board command driver 535, 540. On-board requests are queued by the on-board TCP/IP command driver 540 to a FIFO request queue 560 serviced by the on-board TCP/IP network stack 545. Offload requests are queued by an offload board command driver 535, to a request FIFO, e.g., shared request FIFO 555, to communicate the requests blocks from the host to the TCP/IP network stack in the offload board 575.

For on-board network requests, the on-board TCP/IP network stack 545 dequeues request blocks in order from the request FIFO 560. Data structures (not shown) within the TCP/IP network stack 545 contain the status and operating parameters for each connection. Buffers (not shown) within the TCP/IP network stack 545 receive incoming packets from the network through network interface card (NIC) drivers 565. Outgoing packets to the network are formatted within these buffers and transmitted to the network through the NIC drivers 565. When each subsequent result from a request block is ready, a result block is enqueued by the TCP/IP network stack 545 to the pending event queue 580, for example, by making a call to a central queuing routine, i.e., s64opReady( ) 546.

For the offload board network requests, the TCP/IP offload processor and firmware 575 dequeues request blocks in order from the shared request FIFO 555. Data structures (not shown) within the offload TCP/IP network stack 575 contain the status and operating parameters for each connection. Buffers (not shown) within the offload board receive packets from the network through a network driver and network interface adapters (not shown) contained on the offload board. Outgoing packets to the network are formatted within these buffers and transmitted to the network through the network interface adapters. When each subsequent result from a request block is ready, a result block is enqueued by the TCP/IP offload processor and firmware 575 to the shared results FIFO 570. The offload result processing 550 dequeues result blocks in order from the shared results FIFO 570 and enqueues the result blocks in order to the pending event queue 580 by calling a central queuing routine, e.g., s64opReady( ) 546.

For purposes of illustration, shown in FIG. 5 are five result blocks 581-585, each encoding the intermediate or final parameters for operations specified in the corresponding request blocks. Request blocks are returned in order from the pending event queue 580 when the application 505 issues a s64_qReady( ) request 590 to the qNet connection API 595.

Exemplary qNet Connection API Implementation Details

In the embodiments described below, the qNet connection API can be divided into six categories: configuration, connection status, outgoing connections, incoming connections, connection I/O, and connection control.

Again, while for the purposes of explanation, numerous specific details, including code and data structure examples, are set forth below in order to provide a thorough understanding of embodiments of the present invention, it should be understood that embodiments of the present invention may be practiced without some of these specific details and that the present invention is not intended to be limited to the specific examples provided.

Delivery Services & Configuration

According to one embodiment of the present invention, the qNet communications architecture is organized as a set of delivery services. Each delivery service may represent a unique combination of a physical interface (corresponding to a network connector) and protocol address family. In the examples provided below, delivery services may be numbered starting with 0 and incrementing by one up to one less than the total number of delivery services available. In one embodiment, the maximum number of delivery services supported is 256. The delivery service ID may be used to query information and configure protocol-specific parameters.

In an embodiment in which the maximum number of delivery services supported is 256, each delivery service supports at least one and at most 256 idenities. An identity corresponds to a protocol address that the delivery service will respond to, e.g., an IP address for IPV4. Thus, the full identifier for a delivery service is a 16-bit value formatted as follows:

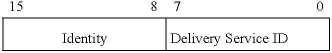

In one embodiment, the identity zero (0) is always valid; some delivery service controls may only be applied to this identity. The number of identities supported by a delivery service is returned as part of the DS_QUERY response.

Global protocol parameters, such as DNS server addresses for IPV4, may be configured through a generic procotol interface. Commands and parameters are interpreted according to the semantics of the specific protocol.

According to one embodiment, all delivery services and protocol/address families support a common query command. This command is used by the application to determine basic information, including whether a specific service or protocol is supported.

Connection Information

According to one embodiment, a generic connection information structure is defined as follows:

typedef struct {

| | |
|---|---|
| u8 ciAF; | // Protocol/Address Family |
| u8 ciFlags; | // Protocol- or Function-dependent flags |
| u8 ciInfo[14]; | // Protocol- or Function-dependent information |

} s64c_connInfo ALIGNED(8);

Each protocol/address family may then have its own command and address structures that overlays the generic structure. In the above example, the first byte defines the type of the address. The second byte is provided for protocol-, command-, or function-specific values. The remaining 14 bytes are available for arbitrary assignment or structure overlay. Note that the structure is properly aligned for 1-, 2-, 4-, or 8-byte access, so a pointer or any integer value may be properly packed in the structure. It is suggested that if the protocol does not use all 14 bytes of information, it should be padded with zeros for future compatibility.

For example, in one embodiment, the TCP/IP (IPV4) address structure is defined as:

typedef struct {

| | | |
|---|---|---|
| u8 | ipv4_af; | // Protocol/Address Family |
| u8 | ipv4_flags; | // Protocol- or Function-dependent flags |
| u16 | ipv4_port; | // Connection port addr (network order) |
| u32 | ipv4_addr; | // Connection IP addr (network order) |
| u64 | ipv4_zero; | //Unused, must be zero |

} ipv4Addr ALIGNED_DECL(8);

Connection Status

According to one embodiment, when a request is completed, the following status information is available:

typedef struct {

| | | |
|---|---|---|
| s64c_param | qrParam; | // Opaque parameter from queued request |
| s64c_handle | qrHandle; | // Associated handle value |
| s64c_status | qrStatus; | // Error code |
| u64 | qrInfo[2]; | // Command dependent information |

} s64c_qr;

As described above, in one embodiment, results from requests on active connections are queued. To read the results of the next ready item, the application calls may make a call to the qNet connection API in the following form:
s64c_qr result=s64_qReady( );

If no results are available, the value of the handle will be S64C_NOHANDLE. The current status of an individual connection may be queried by calling:

typedef struct {

| | | |
|---|---|---|
| u8 | cnAF; | // Protocol/Address Family - always S64AF_IPV4 |
| u8 | cnFlags; | // Protocol-dependent flags |
| u16 | cnDS; | // Delivery service & identity |
| u32 | cnStatus; | // Connection status |
| u64 | cnInfo; | // Protocol-specific information |

} s64c_cnInfo;
s64c_cnInfo cnInfo;
err = s64_cnControl(handle, CN_QUERY, (s64c_connInfo *) &cnInfo);

where, handle is the connection handle. If handle is not an active connection, the call will return EBADF. Otherwise, ENOERROR is returned, and status information bits will be set in cnInfo.cnStatus (see description relating to s64_cnControl( ) for further details).
Outgoing Connections

According to one embodiment, outgoing connections may be created either by specifying the full protocol address information, or specifying the host name in lieu of the address and the remaining protocol information. For example, an outgoing connection to an internal web server at 192.168.1.50 may be established by the following:

ipv4Addr serverAddr;
serverAddr.ipv4_af = S64AF_IPV4;
serverAddr.ipv4_flags = IPV4_TCP;
serverAddr.ipv4_port = s64_htons(80);
serverAddr.ipv4_addr = s64_htonl(0xC0A80138);
serverAddr.ipv4_zero = 0;
err = s64_connectAddr((s64c_connInfo *) &serverAddr, p);

where, p is an arbitrary opaque parameter provided by the application that helps the application identify the completed request. The programming example below shows how an application might take advantage of this opaque parameter.

The return value indicates whether the request was successfully started. In one embodiment, the normal return code is ENOERROR; s64_connectAddr( ) may also return EAGAIN, which indicates that the system does not have the resources to initiate the connection immediately; the request may be retried later.

Recall, even after a result is returned from s64_qReady( ), the actual network connection sequence (e.g., three-packet handshake in TCP) may not have even begun. However, in accordance with various embodiments of the qNet connection API and communications architecture, it is still permissible to queue read and/or write requests to the connection before it is established. For example, when connecting to a server, the application can initiate the connection, then immediately queue a buffer containing an HTTP request to the connection. This, in turn, may speed up the transfer if the underlying network interface supports TCP accelerated open.

According to one embodiment, outgoing connections may also be established by calling:
err=s64_connectHost(name, (s64c_connInfo*) &serverAddr, p);
where, name is the host's name (e.g., www.yahoo.com), and serverAddr specifies the remainder of the protocol-specific information. Each address/protocol family may use one or more name resolution schemes. In one embodiment, DNS is always supported. For DNS, the API call may convert the domain name into the DNS wire format, then queue the request. In one embodiment, the domain name is expected to follow the rules of RFC 1035; otherwise, EINVAL is returned. Like s64_connectAddr( ), the normal return value is ENOERROR; however, the result value will not be available until the DNS resolution has completed or failed.
Incoming Connections

According to one embodiment, incoming connections differ from outgoing connections in two ways: first, it is possible to have an arbitrary number of completions, i.e., new connections, in response to one incoming connection request; second, it is not possible to know when the completions will occur.

In one embodiment, the application advertises willingness to accept incoming connections by calling s64_acceptAddr( ). To accept requests on the HTTP port (80), an exemplary code sequence might be expressed as follows:

ipv4Addr svcAddr;
svcAddr.ipv4_af = S64AF_IPV4;
svcAddr.ipv4_flags = IPV4_TCP;
svcAddr.ipv4_port = s64_htons(80);
svcAddr.ipv4_addr = 0;
svcAddr.ipv4_zero = 0;
err = s64_acceptAddr(&svcAddr, p);

where, svcAddr specifies the IP and TCP port address used to connect from the remote machine. In the IPV4 address family, an IP address of zero may indicate that the connections will be accepted on all delivery services that implement IPV4. As with other functions, p is an opaque parameter that helps the application identify the new connections. In one embodiment, the same parameter will be returned for all new connections on the specified service address.

Once s64_acceptAddr( ) has been called, one or more connection completions will be queued. Like results from s64_connectAddr( ) and s64_connectHost( ), the actual connection may not be complete. However, the remote address will be known, and the handle may be used to queue a read and/or write request; in the normal case where the server reads a client request first, this allows the server to move over data as soon as it's available.

Connection I/O

According to various embodiments, once a connection handle has been returned to the application, at most one read and one write request will be accepted on the connection. Example function calls to initiate the read and write are:
err=s64_readConnection(handle, buf; len, p);
err=s64_writeConnection(handle, buf; len, p);
where, handle is the connection handle; buf and len are the properly aligned buffer address and buffer length in characters, respectively. Depending upon the particular implementation, the behavior of the read and write requests may be slightly different.

For example, when a read request is complete, the count of bytes read may be less than the requested size—the networking system will not necessarily wait for the buffer to fill before declaring the read complete. Meanwhile, in one embodiment, the read data has been transferred to the specified buffer before the completion is queued. Thus, the application may begin processing the data immediately upon dequeuing the corresponding read request completion.

In contrast, in one embodiment, when a write request is complete, the networking system guarantees that, in the absence of an error, all the data from the application buffer has been copied into its memory. Consequently, the application may change the value in the buffers without affecting transmission. In one embodiment, it is also guaranteed that the data will be transmitted in the order it was written to the connection. However, it is not guaranteed that any of the data has been transmitted on the network.

Closing Connections

According to the present example, when an established connection needs to be closed, two calls are provided by the qNet connection API to do so:
err=s64_connectClose(handle, param);
which closes the connection for further reads and write, but attempts to deliver all previously written data, and
err=s64_connectReset(handle, param);
which also closes the connection for farther reads and write, but may discard all previously written data. According to one embodiment, if a connection is closed or reset and there are no pending I/O operations, the return value will be ENOERROR; further, no result will be queued for the operation. However, if there are pending operations, e.g., a connection is being aborted due to timeout:
Pending requests will be terminated (but see below). Any read data will be discarded. Some, none, or all of the write data may have been copied into the network buffers and be available for transmission if the connection is not being reset.
Completed requests will be removed from the completion queue (e.g., the pending event queue 580) and their results will not be returned to the application through s64_qReady( ).
The call will return EINPROGRESS. This indicates that the application must wait for a result tagged with the parameter passed with the request. This result signals that the data transfers are inactive, and that the buffer(s) associated with the request(s) are safe to free or use.

Even though the handle has not really been closed, the only operation available on the handle is to query the status. When the result is read from the pending event queue 580, the system has closed the handle—the application need not (and cannot) close or reset again.

In a multiprocessor configuration, it is possible that one processor can get the results for a request that is being closed on another processor. The application must guard against this race condition if a connection is closed or reset with pending I/O. A possible solution is to simply mark the connection as “dead” and allow the completion handler to perform the actual close.

To stop accepting new connections, the application may make calls in the following form:
err=s64_closeAddr(&ipAddr);
where, ipAddr is the IP and port addresses to shut down. As when calling s64_acceptAddr( ), if the IP address is 0, the port will be shut down on all machine interfaces. Any connection completions will be removed from the results queue; like closing an outgoing connection, consequently there can be an MP race condition between reading the connection results and disabling incoming requests.
Programming Example

Embodiments of the qNet connection API and communication architecture described herein seek to address various deficiencies of the BSD socket interface by insuring one or more of the following conditions:
When a request is completed, the associated data has already been sent or received.
Completed requests are returned in the order completed, ensuring fair, round-robin scheduling.
Multiple processors can naturally queue connections and obtain connections without any locking above what the kernel requires: for many designs this substantially reduces the amount of locking and contention, enhancing multiprocessor scaling.

The following code example is only meant to illustrate the efficiency of an embodiment of the qNet connection API, and is only a basic description. In this sample application, a server allows one incoming connection, processes the input data, sends a response, and then listens again. Things are initiated by calling:
ipv4Addr myPort={S64C_IPV4, IPV4_TCP, MY_PORT, 0, 0);
s64_acceptAddr(&myPort, (s64c_param) &myStruct);

where, myStruct is the application's state processing structure (struct stateStruct), which may contain, among other things, a function pointer to handle the next step in the state machine. The control loop for processing is extremely simple:

```
extern int keepOnTrucking;  // Global flag to continue processing
do {
  struct s64c_qr q;
  struct stateStruct *me;
  q = s64_qReady( );
  if (q.qrHandle != S64C_NOHANDLE) {
      me = (struct stateStruct *) q.param;
      (*me->nextState)(me, &q);
  }
} while (keepOnTrucking);
```

Note that while the loop is simple, there need not be any changes for multiprocessing, nor would the loop need to change for multiple connections, as long as the parameter passed to the queuing request uniquely identifies the application's per-connection state structure.

As another example, consider a loop managing multiple connections where the processing for each connection is largely, but not entirely, driven by I/O events on the connections. For this case, the control loop is similar and may be of the form:

```
do {
  struct s64c_qr q;
  struct stateStruct *me;
  q = s64_qReady( );
  if (q.handle == S64C_NOHANDLE)
      break;
  me = (struct stateStruct *) q.param;
  (*me->complete)(me, &q);
} while (1);
processConnections( );
```

One principal difference in this example is that the state routine only processes the completion; lengthier processing is now invoked by processConnections( ). However, any processor can get completed requests and process connections, so that if one processor or core is busy with a lengthy computation, other connections can still make forward progress.

Without loss of generality, various defined constants, types, status codes, control interfaces, FIFOs, queuing structures, connection interfaces, I/O interfaces, result and status interfaces, multiprocessor locking referred to herein are now described in accordance with one embodiment of the present invention. Those skilled in the art will appreciate that more or fewer interfaces may be provided.

Defined Constants

S64C_NOHANDLE A guaranteed invalid connection handle value.
   Types
s64c_block A block number in the system NVRAM.
s64c_count A data transfer count.
s64c_port A 16-bit TCP or UDP port number.
s64c_flag Various flags to API functions.
s64c_handle The 32-bit system identification for a connection.
s64c_param An opaque parameter type; in one embodiment, guaranteed large enough to hold a pointer
s64c_service A 64-bit delivery service identifier.
s64c_status An API or request completion code.
s64c_tmo A timeout value, in seconds
   Status Codes
EAGAIN The system cannot accept this request now, may try again
EBADF Invalid connection handle
EBUSY Connection or delivery service busy
ECONNABORTED Connection was aborted
ECONNREFUSED Connection refused
ECONNRESET Connection was reset
EINPROGRESS Operation is in progress
EINVAL Invalid parameter or operation
ENETDOWN The specified network is down
ENETUNREACH The specified network cannot be reached
ENOTCONN The specified handle is not connected
ENODEV No valid delivery service found
ENOERROR Command or request completed without error
ENOSPC Insufficient memory or table space to complete the operation
EPIPE Write to a connection shut down or closed by peer
ETIMEDOUT Operation or connection timed out
   Control Interfaces
   s64 afControl( )
   s64c_status
   s64_afControl(const u64 cmd, s64c_connInfo *info)

Get or set information about the address family specified by info. The identifying tags for address families, e.g., IPV4, may be defined in a qNet interface file. The following commands may be defined for all address families:
AF_QUERY This command returns a descriptive string in the ciInfo [symbol] field. This command may be used to check if the specific address family is supported.
AF_CACHE This command allows the application to inform the address family that the specified address, in protocol-specific format, is important and that information about it, e.g., the associated MAC address, should be cached with high priority. The address family and/or the underlying delivery service(s) may silently ignore this command.

In one embodiment, all other commands are address family specific, as are the values passed or returned through the info pointer.

Return Values:

ENODEV The specified address family does not exist
EBUSY The specified command cannot be executed, usually because one or more related delivery services are enabled.
EINVAL Info parameter(s) invalid.
EINVAL Command not valid for specified address family.
EINVAL The info address is invalid.
   Result Values:

This is a synchronous request: no result is returned.

s64 dsControl( )

s64c_status

s64_dsControl(const u64 ds, const u64 cmd, s64c_connInfo *info)

Get or set information about the specified delivery service and identity. Delivery services are densely numbered starting from zero (0), as are identities. The following commands are defined for all delivery services:

DS_QUERY This command returns the following information about the delivery service:

| typedef struct { | |
|---|---|
| u8 dsAF; | // Protocol/Address Family |
| u8 dsInstance; | // Instance of this delivery service |
| u8 dsEnable; | // 0 = disabled |
| u8 dsInfo[13]; | // NUL-terminated description |

} s64c_dsInfo ALIGNED_DECL(8);

This command may be used to check if the specific delivery service and identity exist.

DS_NIC This command returns the following information about the delivery service hardware:

| typedef struct { | |
|---|---|
| u8 dsAF; | // Protocol/Address Family |
| u8 dsMAC[6]; | // Hardware MAC Address |
| u8 dsNIC[9]; | // NUL-terminated description |

} s64c_dsNIC ALIGNED_DECL(8);

This command may also be used to check if the specific delivery service and identity exist.
DS_ENABLE This command enables the associated delivery service. Note that delivery services are enabled when their address is configured, and may not change the address when enabled. The info parameter may be ignored and may be NULL.
DS_DISABLE This command disables the associated delivery service. Disabling a delivery service may not modify its configuration. The info parameter may be ignored and may be NULL.
DS_CLEAR This command clears addressing information, e.g., an ARP cache, associated with the delivery service. The info parameter may be ignored and may be NULL.

According to this example, all other commands are delivery specific, as are the values passed or returned through the info pointer.

Return Values:

ENODEV The specified delivery does not exist.
EBUSY The specified command cannot be executed, usually the delivery service is enabled.
EINVAL Input address family or parameters are not valid or recognized.
EINVAL Command not valid for specified delivery service.
   Result Values:

This is a synchronous request: no result is returned.

s64 cnControl( )

s64c_status

s64_cnControl(s64c_handle h, const u64 cmd, s64c_connInfo *info)

Get or set information about the specified delivery service. The following commands are defined for all connections:

CN_QUERY This command returns the following information about the connection:

typedef struct {

| | | |
|---|---|---|
| u8 | cnAF; | // Protocol/Address Family |
| u8 | cnFlags; | // Protocol-dependent flags |
| u16 | cnDS; | // Delivery service & identity |
| u32 | cnStatus; | // Connection status |
| u64 | cnInfo; | // Protocol-specific information |

} s64c_cnInfo;

CN_SHUTDOWN Set the connection so that no subsequent writes will be accepted. If the underlying protocol allows, send the end-of-data signal after all data has been transmitted. If there is a write pending, it will complete normally. The info parameter may be ignored and may be NULL.
   For CN_QUERY, cnAF is the address family of the connection, and cnFlags is protocol-dependent information. cnDS is the delivery service and identity. cnStatus is the connection status; bits may be set as follows:
S64C_CONN_FAILED The connection failed to complete
S64C_CONN_CLOSED The connection was closed by the remote machine or other error
S64C_READ_PENDING A read request is pending
S64C_READ_DONE A read request complete and results are available
S64C_WRITE_PENDING A write request is pending
S64C_WRITE_DONE A write request complete and results are available

In one embodiment, the connection status bits are mutually exclusive; if none are set, the connection is live.

In one embodiment, the read status bits are mutually exclusive; if none are set, there is no read request pending or completed.

In one embodiment, the write status bits are mutually exclusive; if none are set, there is no write request pending or completed.

According to the present example, all other commands are address family or delivery-service specific, as are the values passed or returned through info.

Return Values:

EBADF Invalid connection handle
EINPROGRESS A connection was shut down with a write or write result pending.
EINVAL The info address is invalid.
   Result Values:

This is a synchronous request: no result is returned.

Connection Interfaces

s64 connectAddr( )

s64c_status

s64_connectAddr(s64c_connInfo *dest, s64c_param param)

According to one embodiment, s64_connectAddr( ) initiates a connection to the specified address. The address family is specified in the first field of dest; the interpretation of the remainder if the structure is address family dependent. The type parameter is an address-family specific value defining the type of connection to be established. Results may available as soon as the appropriate network interface has initiated the request. This means that the network connection may not have completed yet; however, the handle may be used to initiate a read and/or a write.

If the connection request fails (qrStatus!=ENOERROR), the handle is invalid: no further operations, including closing, can be initiated.

Return Values:

ENOEROR The normal return value: the connection request was successfully initiated.
EAGAIN The system doesn't have the resources to create the connection right now. The request can be attempted later.
ENODEV The specified address family is not supported.
EINVAL The specified address is not valid.
ENETDOWN The required delivery service is not enabled
ENETUNREACH The specified address cannot be reached from this system
   Command-Specific Result Values:
qrInfo s64c_connInfo structure. ciAF designates the address family; the remainder of the structure is protocol-specific.
   Result Status:
ENOERROR The connection was initiated without error and is available for I/O
EAGAIN The network interface doesn't have the resources to create the connection right now. The request can be attempted later.
ENETUNREACH The specified IP address cannot be reached.
ECONREFUSED The specified host refused to allow connection
ECONABORTED The specified host aborted connection
ECONRESET The specified host reset the connection
ETIMEDOUT The connection timed out.
   Implementation Notes:

In one embodiment, once the handle is successfully returned, it may be in all ways treated as if the connection had actually completed.

If a read or write request is queued, and the connection fails, the associated status may be reflected in the results for any pending I/O request.

s64 connectHost( )

s64c_status

s64_connectHost(char *host, s64c_connInfo *addr, s64c_param param)

According to one embodiment, s64_connectHost( ) creates a connection to the specified hostname, using the address-family specific parameters from addr. In one embodiment, the host name must follow the rules of RFC 1035. Results will available as soon as the DNS resolution has completed and the appropriate network interface has initiated the request. This means that the network connection may not have completed yet; however, the IP address will be valid, and the handle may be used to initiate a read and/or a write.

If the connection request fails (qrStatus!=ENOERROR), the handle is invalid: no further operations, including closing, can be initiated.

Return Values:

ENOERROR The normal return value, since the request is asynchronous.
ENODEV The specified address family is not supported.
EAGAIN The system doesn't have the resources for DNS resolution or to create the connection right now. The request can be attempted later.
ENETDOWN The required delivery service is not enabled
ENETUNREACH DNS is not configured on the system
EINVAL The specified host name is not a legal DNS name (see RFC 1035 for details)
   Command-Specific Result Values:
qrInfo s64c_connInfo structure. ciAF designates the address family; the remainder of the structure is protocol-specific.
   Result Status:
ENOERROR The connection was initiated without error and is available for I/O
EAGAIN The network interface doesn't have the resources for DNS resolution or to create the connection right now. The request can be attempted later.
EINVAL The hostname cannot be resolved on DNS
ETIMEDOUT DNS resolution failed or the connection attempt timed out
ENETDOWN The required delivery service is not enabled
ENETUNREACH The specified host address cannot be reached
ECONREFUSED The specified host refused to allow connection
ECONABORTED The specified host aborted connection
ECONRESET The specified host reset the connection
   Implementation Notes:

In one embodiment, the network system completes the DNS look-up without blocking the application. The completion result is available after the IP address is known or the DNS look-up fails.

In one embodiment, the system will perform DNS caching (if possible) to improve speed.

s64 acceptAddr( )

s64c_status

s64_acceptAddr(s64c_connInfo *addr, s64c_param param)

According to one embodiment, s64_acceptAddr( ) enables notification of incoming connections on the specified address. If the address a protocol-specific wildcard address, incoming connections will be accepted on all delivery services that support the specified address family; otherwise, the address is assumed to be a local delivery service and not already accepting connections on the specified port. For each incoming connection, a separate connection result will be queued; however, in one embodiment, each will return the same opaque parameter.

Return Values:

ENOERROR The normal return value.
ENODEV The specified address family is not supported.
EAGAIN The system doesn't have the resources to create the connection right now. The request can be attempted later.
ENETDOWN The required delivery service is not enabled
ENETUNREACH DNS is not configured on the system
EINVAL The specified address is not a system address or invalid
   Command-Specific Result Values:
qrInfo s64c_connInfo structure. ciAF designates the address family; the remainder of the structure is protocol-specific.
   Result Status (For Each Incoming Connection):
ENOERROR The connection was allocated without error and is available for I/O.
EAGAIN The network interface doesn't have the resources to accept connections on the specified port right now. The request can be attempted later.
EBUSY The specified IP and port are in use
   Implementation Notes:

According to one embodiment, the networking system will reject IP addresses specified by the s64_controlIP( ) call, and may ignore or drop connections if insufficient resources are available. The performance statistics may include counters for these events.

In practice, the network system may limit the number of ports on which incoming connections can be accepted; however, preferably there will be no fewer than 8 available ports per system IP address.

I/O Interfaces

s64 readConnection( )

s64c_status

s64_readConnection(s64c_handle h, void *buf, s64c_count len, s64c_param p)

According to one embodiment, s64_readConnection( ) queues a read request on the specified handle. Up to len bytes of the connection are transferred to a 16-byte aligned buf before the request is queued as complete; however, the system may transfer less data for system-specific reasons.

Return Values:

ENOERROR Read was successfully initiated.
EAGAIN The system doesn't have the resources to queue the request right now. The request can be attempted later.
EBADF Invalid connection handle
EINVAL The specified buffer is misaligned or an illegal address
EINPROGRESS A second read request we made before the first request is completed
ENOTCONN The handle is no longer connected
   Command-Specific Result Values:
qrBSize Original buffer size
qrCount Count of bytes transferred to the buffer (status==ENOERROR). If zero, then end-of-data has been signaled on the connection.
qrToken Protocol specific 64-bit token.
   Result Status:
ENOERROR The read completed without error; however, few bytes may have been transferred than originally requested
ECONABORTED The host aborted connection
ECONRESET The host reset the connection
ENOTCONN The handle is no longer connected
   Implementation Notes:

According to one embodiment, reads may complete with ENOTCONN when a connection is broken after the request is accepted. For example, the first read from a connection will return this status if the connection failed to complete.

s64 writeConnection( )

s64c_status

s64_writeConnection(s64c handle h, void *buf s64c_count len, s64c_param p)

According to one embodiment, s64_writeConnection( ) queues a write request on the specified handle. len bytes of the connection are transferred from a 16-byte aligned buf before the results are available. When a successful result (status==ENOERROR) is returned, the network interface is said to have taken custody of the data: the application may reuse the buffer without affecting the data transmitted to the network. All data is transmitted over the connection in the order it was queued.

Return Values:

ENOERROR The normal return value.
EAGAIN The system doesn't have the resources to queue the request right now. The request can be attempted later.
EBADF Invalid connection handle
EINVAL The specified buffer is misaligned or an illegal address
EINPROGRESS A second write request was made before a pending request has completed
EPIPE Data written on a connection that has been shut down
EPIPE Data written on a broken connection with no other pending data
   Command-Specific Result Values:
qrBSize Original buffer size
qrCount Count of bytes transferred from the buffer. Will always equal qrBSize if there is no error.
qrToken Always zero (0x0).
   Result Status:
ENOERROR The write completed without error
EPIPE Data written on a broken connection with no other pending data
ECONABORTED The host aborted connection
ECONRESET The host reset the connection; other data was pending
   Implementation Notes:

In one embodiment, write may complete with EPIPE when a connection is broken after the request is queued. In particular, the first write to a connection will return this if the connection fails to complete.

s64 sendConnection( )

s64c_status

s64_sendConnection(s64c_handle h, void *buf, s64c_sendInfo *sp, s64c_param p)

According to one embodiment, s64_sendConnection( ) queues a write request on the specified handle according to the values in sp. The send parameters are the following structure:

typedef struct {

| | | |
|---|---|---|
| u8 | send_af; | // Protocol/Address Family |
| u8 | send_flags; | // Protocol- or Function-dependent flags |
| u16 | send_data; | // Protocol- or Function-dependent misc |
| u32 | send_len; | // Transmission length |
| u64 | send_token; | // Protocol-dependent token |

} s64c_sendInfo ALIGNED_DECL(8);

sp->send_len bytes of the data are transferred from the specified buf before the results are available. When a successful result (status==ENOERROR) is returned, the network interface is said to have taken custody of the data: the application may reuse the buffer without affecting the data transmitted to the network. All data is transmitted over the connection in the order it was queued.

In each protocol family, not all connection types may support s64_sendConnection( ). For example, a TCP connection under IPV4 does not; however, UDP endpoints do.

Return Values:

ENOERROR The normal return value.
EAGAIN The system doesn't have the resources to queue the request right now. The request can be attempted later.
EBADF Invalid connection handle
EINVAL The specified connection does not support s64_sendConnection( ).
EINVAL The specified buffer is misaligned or an illegal address
EINPROGRESS A second write request was made before a pending request has completed
EISCONN Send attempted on a connection-oriented handle (e.g., TCP)
EPIPE Data written on a connection that has been shut down
EPIPE Data written on a broken connection with no other pending data
   Command-Specific Result Values:
qrBSize Original buffer size
qrCount Count of bytes transferred from the buffer. Will always equal qrBSize if there is no error.
qrToken Always zero (0x0).
   Result Status:
ENOERROR The write completed without error
EPIPE Data written on a broken connection with no other pending data
ECONABORTED The host aborted connection
ECONRESET The host reset the connection; other data was pending
   Implementation Notes:

According to one embodiment, write may complete with EPIPE when a connection is broken after the request is queued. In particular, the first write to a connection may return this if the connection fails to complete.

s64 passThru( )

s64c_status

s64_passThru(s64c_handle src, s64c_handle dst, s64c_param p)

According to one embodiment, s64_passThru( ) queues a request to directly pass data from the input of the handle src to the output handle dst. The network subsystem transfers the data as efficiently as possible. The result handle will be src, and the buffer size and byte count may both reflect the number of data bytes passed thru exclusive of protocol headers.

Whether data can be passed directly between two handles is dependent on the implementation of the corresponding delivery services and the type of connection. In general, delivery services with different identifiers, different types of connections, and multiplexed connections (e.g., UDP in IPV4) may not support pass-thru.

Return Values:

ENOERROR Normal return value.
EAGAIN The system doesn't have the resources to queue the request right now. The request can be attempted later.
EBADF Invalid connection handle
EINVAL Pass-thru mode is not supported between the specified handles
EINPROGRESS A second pass-thru request was made before a pending request has completed
EINPROGRESS A read is already pending on the source handle
EINPROGRESS A write is already pending on the destination handle
EPIPE Data written on a connection that has been shut down
EPIPE Data written on a shut down or broken connection with no other pending data
   Command-Specific Result Values:
qrBSize Data bytes passed to destination handle
qrCount Count of bytes transferred from the buffer. In one embodiment, will always equal qrBSize if there is no error.
qrToken Protocol specific 64-bit token.
   Result Status:
ENOERROR The write completed without error
EPIPE Data written on a broken connection with no other pending data
ECONABORTED The host aborted connection
ECONRESET The host reset the connection; other data was pending
   Result and Status Interfaces
   s64 qReady( )
   s64c_qr
   s64_qReady(void)

According to one embodiment, s64_qReady( ) takes the next completed request from the ready queue (e.g., the pending event queue 580). If there is no result immediately available, the handle of the return status will be S64C_NOHANDLE. Otherwise, the fields qrParam and qrStatus will always be set; other operation-dependent information may be union'd with the qrInfo structure.

Control Interfaces

s64 connectClose( )

s64c_status

s64_connectClose(s64c_handle handle, s64c_param p)

According to one embodiment, s64_connectClose( ) closes the specified connection. When a connection is closed, the system will continue to transmit queued data until the data is exhausted or the connection is broken.

When there are no pending read or write operations and no results queued, s64_connectClose( ) returns ENOERROR and no further results will be available on that handle. In this case, the 64-bit opaque parameter p is ignored.

When there is a pending read or a read result available, s64_connectClose( ) returns EINPROGRESS instead of ENOERROR. The network may transfer zero or more bytes for the read before returning a normal result, with or without an error.

When there is a pending write or a write result available, s64_connectClose( ) returns EINPROGRESS instead of ENOERROR. In one embodiment, the network will finish the write transfer before returning a normal result, with or without an error.

When one or more operations are pending and/or results queued, a result message may be queued with the parameter specified to the s64_connectClose( ) call. This result may be queued after all other results for the connection, and indicates that the connection is quiescent and closed.

Return Values:

ENOERROR The connection handle is no longer valid for system calls; subsequent operations on the handle will return EBADF.
EINPROGRESS Operation(s) are pending and/or result(s) are available for the connection; the application should wait for a completion (see below). The connection handle is no longer valid for system calls; subsequent operations on the handle may return EBADF.
EBADF Invalid connection handle
   Command-Specific Result Values (After EINPROGRESS):
NONE
   Implementation Notes:

In one embodiment, the API guards against other operations concurrent with s64_connectClose( ), so that the state of the connection will be consistent. There is an intrinsic race between a connection being closed on one CPU and a result being processed on another. If closing a connection before all outstanding operations have completed, the application is responsible for guarding against this race condition.

s64 connectReset( )

s64c_status

s64_connectReset(s64c_handle handle, s64c_param p)

According to one embodiment, s64_connectReset( ) resets the specified connection. When a connection is reset, all, some, none of the queued data may be transmitted; if possible, the connection may be reset.

When there is a pending read or a read result available, s64_connectReset( ) returns EINPROGRESS instead of ENOERROR. The read operation may be aborted as soon as possible, and the result discarded.

When there is a pending write or a write result available, s64_connectReset( ) returns EINPROGRESS instead of ENOERROR. The write operation may be aborted as soon as possible, and the result discarded.

When one or more operations are pending and/or results queued, a result message may be queued with the parameter specified to the s64_connectReset( ) call. This result indicates that the connection is quiescent and closed.

Return Values:

ENOERROR The connection handle is no longer valid for system calls; subsequent operations on the handle will return EBADF.
EINPROGRESS Operation(s) are pending and/or result(s) are available for the connection; the application must wait for a completion. The connection handle is no longer valid for system calls; subsequent operations on the handle will return EBADF.
EBADF Invalid connection handle
   Command-Specific Result Values (After EINPROGRESS):
NONE
   Implementation Notes:

In one embodiment, the API guards against other operations concurrent with s64_connectReset( ), so that the state of the connection will be consistent. There is an intrinsic race between a connection being reset on one CPU and a result being processed on another. If resetting a connection before all outstanding operations have completed, the application is responsible for guarding against this race condition.

s64 closeAddr( )

s64c_status

s64_closeAddr(s64c_connInfo *ip, s64c_flag discard)

According to one embodiment, s64_closeAddr( ) stops the acceptance of new connections on the specified address. If discard is non-zero, any pending connections will be reset and discarded from the completion queue (e.g., the pending event queue 580). Otherwise, pending connections will be delivered normally; this mode is supported for graceful shutdown.

Return Values:

ENODEV The specified address family is not supported.
ENOERROR New connections will no longer be accepted from the specified address.
   Result Status:

No completion is signaled for this request.

Implementation Notes:

In one embodiment, if discarding, completed connections will be removed from the results queue; like closing an outgoing connection, there can be an MP race condition between reading the connection results and disabling incoming requests. Invalid IP addresses and/or ports are silently ignored.

Protocols

The IPV4 protocol is designated by the defined constant S64AF_IPV4. While the TCP and UDP protocols are the only protocols described in the examples below, those skilled in the art will appreciate that other protocols may be supported. According to one embodiment, a structure that may be used to encapsulate IP addresses is:

typedef struct {

| | | |
|---|---|---|
| u8 | ipv4_af; | // Protocol == S64AF_IPV4 |
| u8 | ipv4_flags; | // Request specific flags |
| u16 | ipv4_port; | // Port value (network byte order) |
| u32 | ipv4_addr; | // Destination address (network byte order) |
| u64 | ipv4_info; | // Protocol specific value, 0 if unused |

} ipv4Addr ALIGNED_DECL(8);

In one embodiment, the IP address and 16-bit port number are stored in network byte order (big endian). The ipv4_info field is available for protocols other than TCP and UDP if addition information is required. For TCP and UDP, the field is set to zero.
Connections

According to one embodiment, the connection type to be accepted (s64_acceptAddr( )) or initiated (s64_connectAddr( ), s64_connectHost( )) is designated by setting the ipv4_flags field to the standard protocol number for TCP (IPV4 _PROTO_TCP) or UDP (IPV4 _PROTO_UDP).

When initiating a connection, the local IP address and port number may be automatically selected by the system and may be queried through the connection handle. When the connection completes, the remote IP and port addresses are available in the return status.

When preparing to accept incoming connections, the caller may specify the local IP address and port number. If the address is 0x0, connections may be accepted on all delivery services that support the IPV4 protocol; otherwise, the address is assumed to correspond to a delivery service. When a new connection is completed, the remote IP and port addresses are available in the return status.

Endpoint Address

According to one embodiment, when a source or destination IP address is specified to a command or in a result, the following 64-bit structure may be used:

typedef struct {

| | | |
|---|---|---|
| u16 | ipv4ep_flags; | // Request specific flags |
| u16 | ipv4ep_port; | // Port value (network byte order) |
| u32 | ipv4ep_addr; | // Address (network byte order) |

} ipv4endPoint ALIGNED_DECL(8);

Send and Receive

In one embodiment, for TCP connections, the protocol-specific results token will always be zero. The s64_sendConnection( ) function is identical to the s64_writeconnection( ); the specified token may be ignored. Since TCP is a reliable byte stream, actual packet boundaries may not be preserved.

According to one embodiment, the UDP implementation has several differences from TCP owing to the packet-oriented, connectionless nature of UDP communication. Even though the same API calls are used, the term mux will be used to distinguish UDP communications. The value of the token specified to s64_sendConnection( ) and returned from s64_qReady( ) is an IP endpoint address, defined above.

UDP muxes may be distinguished by whether the connection was outgoing (initiated by the application) or incoming (accepted by the application). On an incoming mux, the local IP address and port are anchored: only packets sent to the specified IP address and port will be read on the mux; the result token may be the source IP address and port. When a packet is sent using s64_sendConnection( ), the token specifies the destination IP address and port, while the source is taken from the anchor value.

When a mux is initiated by the application, the destination IP address and port are anchored: all packets will be delivered to the same destination, and only packets from the specified IP address and port will be read on the mux. When a packet is sent using s64_sendConnection( ), the token specifies the source IP address and port; this allows the application to send from different ports on the same connection.

In one embodiment, unlike TCP, UDP packet boundaries are always preserved. If the application reads fewer bytes than are available in the packet, any unread bytes will be discarded. Further, it is possible for packets to be dropped, and for duplicate packets to be received; the higher-level protocol (e.g., DNS) must manage this.

ICMP

According to one embodiment, the application can establish one ICMP connection per IPV4 delivery service by calling s64_acceptAddr( ) with the flags set to IPV4 _PROTO_ICMP. In one embodiment, reads from the resulting handle will return the ICMP payload; send may deliver the ICMP payload to the specified endpoint, if reachable on the associated delivery service. The network stack checks the ICMP checksum on input, and generates it on output.

IP Routing

In one embodiment, IPV4 maintains a routing table for all delivery services that implement the IPV4 protocol. Entries are introduced in one of two ways:
When a delivery service is configured, an entry is made that indicates that a specified matching address can be directly delivered on the designated interface.
Routes can be explicitly added with the AF_IPV4 _ROUTE command to s64_afControl( ).

Conceptually, the routing table consists of quadruples of the form
{netaddr, netmask, hop, dsID}

According to one embodiment, the routing table is sorted first by the subnet mask, largest netmask values first, then by IP addresses in ascending order. Thus, if two interfaces are configured on the same subnet, the lowest IP address will be used for all outgoing connections.

Address Family Commands

According to one embodiment, the response to the AF_QUERY command will set the s64c_connInfo structure as follows:
ciAF←S64AF_IPV4
ciFlags←0x0
ciInfo←“IPV4”

The AF_CACHE command passes the request to all delivery services that may be affected, based on the routing tables. Addresses that cannot be routed may be silently ignored.

In one embodiment, the following additional address family commands are defined for IPV4, and are described below:
AF_IPV4 _CONFIG† Configure delivery service addresses
AF_IPV4 _ROUTE Set or get routing information
AF_IPV4 CTRL† Control IP addresses
AF_IPV4 _DNS Set or get DNS information
   The commands marked with † may require support from each delivery service that implements IPV4.
   AF_IPV4 _CONFIG Configure the Specified Delivery Service

Parameters

typedef struct {

| | | |
|---|---|---|
| u8 | ipv4d_af; | // Protocol == S64C_IPV4 |
| u8 | ipv4d_cmd; | // Operation code |
| u16 | ipv4d_ds; | // Delivery service & identity |
| u32 | ipv4d_addr; | // Delivery service address |
| u32 | ipv4d_mask; | // Subnet mask |
| u32 | ipv4d_bcast; | // Broadcast IP - use 0 for default |

} ipv4dsConfig ALIGNED_DECL(8);

Set

The following values are valid for ipv4_set:
IPV4 _SET_CONFIG Set delivery service configuration
IPV4 _GET_CONFIG Get delivery service configuration
IPV4 _DEL_CONFIG Delete delivery service configuration
   Description

This interface may be used to set, get, or delete the IP address and subnet mask for the specified delivery service. When setting the configuration, the address and subnet mask should not duplicate another address. Further, the bit-wise AND of the address and subnet mask should not be zero. If multiple delivery services are configured on the same subnet, exactly one of the delivery services may be used; however, which one is indeterminate.

IPV4 _SET CONFIG Set delivery Service Configuration

Set the IP configuration for the delivery service, and enable the interface. The broadcast IP can be explicitly set; however, if the value 0x0 is passed in, the broadcast IP address may be computed as:
(ipv4d_addr & ipv4d_mask)|˜ipv4d_mask
IPV4 _GET CONFIG Get Delivery Service Configuration

The address, subnet mask, and broadcast address fields will be written. If the address is zero, the delivery service may not have been configured.

IPV4 _DEL_CONFIG Delete Delivery Service Configuration

This may disable the specified delivery service and reset its configuration. The info parameter may be ignored and may be NULL.

AF_IPV4 _ROUTE Get or Set IPV4 Routing Information

Parameters

typedef struct {

| | | |
|---|---|---|
| u8 | ipv4r_af; | // Protocol == S64C_IPV4 |
| u8 | ipv4r_flags; | // Route command |
| u16 | ipv4r_dsid; | // Delivery service & identity (GET) |
| u32 | ipv4r_addr; | // Destination address |
| u32 | ipv4r_mask; | // Comparison mask |
| u32 | ipv4r_gw; | // Gateway address |

} ipv4Route ALIGNED_DECL(8);

Flags

The following values are valid for ipv4r_flags:
IPV4 _SET_ROUTE Set routing table information
IPV4 _DEL_ROUTE Delete routing table information
IPV4 _GET_ROUTE Get routing information for a specific
   Description

In one embodiment, a routing entry determines what delivery service to use for an IP address, and what the address of the first hop should be; the two addresses will be the same if the delivery service and destination are on the same subnet. The logic used to determine if a routing entry should be used is:
(dest & entry.mask)==entry.addr

There may be one special routing entry, the default gateway, with an address and mask address of zero. This entry, if present, may be used when no other entries satisfy the above logic. One or more default gateways may be specified. There is also a routing entry implicitly created when a delivery service is configured (see below).

IPV4 _SET_ROUTE Set Routing Table Information

When a routing entry is explicitly added, the parameter values may pass the following tests:
The gateway address may be reachable on a configured delivery service. The configuration command will use the existing routing table to determine this. In one embodiment, if this test fails, the command fails with ENODEV.
The address and mask may not already be in the routing table. In one embodiment, if this test fails, the command will fail with EINVAL.

If more than one routing entry satisfies the routing request, the entry with the most specific network mask will be chosen. For example, if the following two entries are present:
<192.168.0.0, 255.255.255.0, 1>
<192.168.0.0, 255.255.0.0, 3>
   then the address 192.168.0.7 will always be routed to delivery service 1, never to delivery service 3.
   IPV4 _DEL_ROUTE Delete Routing Table Information

When a routing entry is deleted, the parameter values may pass the following tests:
The address and mask may be in the routing table. In one embodiment, if this test fails, the command will fail with EINVAL.
The address and mask may not refer to the configuration for a delivery service. In one embodiment, if this test fails, the command will fail with EINVAL.
   IPV4 _GET_ROUTE Get Routing Information

This command allows an application to determine if and how a connection will be routed. According to one embodiment, On input, only ipv4r_addr is used. If the specified address cannot be routed, which can only occur if there is no default gateway, the command may fail and return ENODEV. Otherwise, the delivery service and identity, gateway address, and network mask will be written to ipv4r_dsid, ipv4r_gw and ipv4r_mask, respectively. All other fields will be unchanged.

AF_IPV4 CTRL Control IP Addresses

Parameters

typedef struct {

| | | |
|---|---|---|
| u8 | ipv4c_af; | // Protocol == S64C_IPV4 |
| u8 | ipv4c_block; | // 0 = allow, 1 = block |
| u16 | ipv4c_zero; | // Unused - must be zero |
| u32 | ipv4c_addr; | // Source address - network byte order |
| u32 | ipv4c_mask; | // Address mask - network byte order |
| u32 | ipv4c_pspec; | // Port Mask specification |

} ipv4Control ALIGNED_DECL(8);

Description

In one embodiment, this command specifies source IP and port addresses that should be accepted or blocked. In one embodiment, if ipv4c_block is zero, the address and port will be allowed; otherwise, it will be blocked. If the port address is not part of the filter, ipv4c_pspec should be set to 0x0; otherwise, it may be set to
(portMask<<16)|portVal
where, portMask and portVal are both on network byte order. An incoming connection matches a specification when
(new.addr & mask)==addr &&(new.port &portMask)==portVal
AF_IPV4 _DNS Get or Set DNS Information

Parameters

typedef struct {

| | | |
|---|---|---|
| u8 | dns_af; | // Protocol == S64C_IPV4 |
| u8 | dns_flags; | // DNS command |
| u16 | dns_zero; | // Unused - must be zero |
| u32 | dns_addr[3]; | // Server addresses - network byte order |

} ipv4dnsAddr ALIGNED_DECL(8);

Flags

The following values are valid for dns_flags:
IPV4 _SET DNS Set DNS server entries
IPV4 _GET DNS Get DNS server entries
IPV4 _CLR_DNS Clear the DNS cache
   Description

Even though DNS is not an IP-only protocol, it is intrinsically connected with IPV4, and so is managed under its auspices. Two DNS commands set (IPV4 _SET_DNS) or get (IPV4 _GET_DNS) from one to three addresses for DNS servers. The addresses are in priority order, i.e., dns_addr[0] is the primary server, dns_addr[1] is the secondary server, and dns_addr[2] is the tertiary server. In one embodiment, if a DNS address is 0x0, no server is specified by that entry.

IPV4 _SET_DNS Set DNS Server Entries

When addresses are set, the following tests may be applied:
A primary server may be specified. If this test fails, the command will fail with EINVAL.
A tertiary server may be specified only if a secondary has been specified. If this test fails, the command will fail with EINVAL.
All specified addresses may be reachable given the existing routing tables. If this test fails, the command will fail with ENODEV.
   IPV4 _GET_DNS Set DNS Server Entries

In one embodiment, the active DNS server addresses are copied into dns-addr [symbol] . If dns_addr[0] is 0x0, no DNS servers have been configured.

IPV4 _CLR_DNS Clear the DNS Cache

DNS look-up results may be cached for improved performance. These caches will normally age according to the DNS protocol. However, if the application wants to remove all DNS entries, it may issue this command; the values in dns_addr [symbol] are ignored. If there are DNS look-ups in flight, however, these will not be deleted or aborted.

On-Board TCP (OBTCP) Interface

This section describes various commands, parameters, semantics, and results that may be exchanged between the upper and lower layers of the “on-board” TCP implementation, which mimics off-load board operation using the system CPU, memory, and NIC hardware. According to one embodiment, the on-board TCP implementation is structured as follows:

Calls to the qNet connection API are-converted into OBTCP commands and parameters, which are then inserted into the request FIFO. These commands may be read and interpreted in order; when the specific command is complete, the result (if any) may be queued for delivery to the application. Exemplary commands, parameters, and results are summarized (alphabetically) in the table below; each command is then subsequently discussed in detail below. Each command uses the same 32-byte structure:

typedef struct {

| | | |
|---|---|---|
| u8 | ob_opcode; | // Operation/Command code |
| u8 | ob_flags; | // Operation-depdendent flags |
| u8 | ob_rj45; | // NIC index |
| u8 | ob_identity; | // Identity on this NIC |
| u32 | ob_handle; | // Associated handle (0 for none) |
| u32 | ob_ipAddr; | // IP Address (0 if none) |
| u32 | ob_gateAddr; | // IP of first hop (0 if none) |
| u32 | ob_length; | // Data len (0 if none) |
| u32 | ob_info; | // Operation & protocol dependent info |
| void | *ob_param64; | // Pointer or 64-bit value |

} obCommand ALIGNED_DECL(8);

Not all fields are used for all commands: unused fields should be set to zero. There are several convenient aliases that may be defined for fields that have multiplexed meanings:
ob_protocol Aliases to ob_flags for OB_CMD_ACCEPT, OB_CMD_HANGUP, and OB_CMD_CONNECT.
ob_port Aliases to ob_info for OB_CMD_ACCEPT and OB_CMD_CONNECT.
ob_token Aliases to ob_param64 for OB_CMD_ACCEPT, OB_CMD_HANGUP, and OB_CMD_CONNECT.
ob_data Aliases to ob_param64 for OB_CMD_READ, OB_CMD_WRITE, OB_CMD_SEND, and OB_CMD_RESOLVE_DNS.
ob_reset Aliases to ob_flags for OB_CMD_CLOSE and OB_CMD_QUIESCE.
ob_src Aliases to ob_handle for OB_CMD_PASS.
ob_dst Aliases to ob_dateAddr for OB_CMD_PASS.
ob_mask Aliases to ob_gateAddr for OB_CMD_CONFIG.
ob_bcast Aliases to ob_length for OB_CMD_CONFIG.
ob_enable Aliases to ob_flags for OB_CMD_CONFIG.

Results may be queued using the components of the connection block and may be composed of the following structures or the like:

typedef struct {

| | | |
|---|---|---|
| void | *no_next; | // Next item on queue |
| u64 | no_param; | // Opaque parameter |
| u32 | no_status; | // Result status code |
| u16 | no_dsid; | // Delivery service and identity |
| u16 | no_flags; | // Status flags |
| u64 | no_endPoint; | // Protocol-specific endpoint |
| | | information |

} *s64NetConnect ALIGNED_DECL(8);
typedef struct {

| | | |
|---|---|---|
| void | *no_next; | // Next item on queue |
| u64 | no_param; | // Opaque parameter |
| u32 | no_status; | // Result status code |
| u16 | no_info; | // Op-specific information |
| u16 | no_flags; | // Status flags |
| s64c_count | no_bsize; | // Original buffer size |
| s64c_count | no_count; | // Data bytes transfered |
| u64 | no_token; | // Additional read information |

} *s64NetRead ALIGNED_DECL(8);
typedef struct {

| | | |
|---|---|---|
| void | *no_next; | // Next item on queue |
| u64 | no_param; | // Opaque parameter |
| u32 | no_status; | // Result status code |
| u16 | no_info; | // Op-specific information |
| u16 | no_flags; | // Status flags |
| s64c_count | no_bsize; | // Original buffer size |
| const u32 | no_reserved; | // Reserved, read-only |

} *s64NetWrite ALIGNED_DECL(8);

According to the present example, there is one overall s64NetConnBlock structure per active connection supported by OBTCP. For each result delivered, it is queued by calling s64_opReady( ) with a pointer to one of the connect, read, or write structures. How the values are set is discussed with each command; the value for no_flags is the value passed to s64_opReady( ). Consequently, no flags should not be set directly by the OBTCP code.

TABLE 1
OBTCP Commands

| Command | Parameters | Results |
|---|---|---|
| OB_CMD_ACCEPT | protocol, NIC, identity, | new handle, |
| | token, port | dsid, token, |
| | | endpoint |
| OB_CMD_CACHE | NIC, address | NONE |
| OB_CMD_CLOSE | Handle, flags | NONE |
| OB_CMD_CONFIG | identity, address, mask, | NONE |
| | broadcast address, | |
| | enable flag | |
| OB_CMD_CONNECT | identity, protocol, | new handle, |
| | address, port, gateway, | dsid, token, |
| | token | endpoint |
| OB_CMD_EOF | handle | NONE |
| OB_CMD_HANGUP | identity, port, protocol | NONE |
| OB_CMD_PASS | source handle, | length |
| | destination handle | |
| OB_CMD_QUIESCE | handle, flags | handle |
| OB_CMD_READ | handle, data, length | handle, |
| | | status, |
| | | resid |
| OB_CMD_RESOLVE_DNS | server, gateway, host | address, host |
| | name, length, info | name, |
| | | length, info |
| OB_CMD_SEND | handle, data, length, | handle, |
| | endpoint | status, |
| | | resid |
| OB_CMD_WRITE | handle, data, length | handle, |
| | | status, |
| | | resid |

OB_CMD_CONFIG Configure Delivery Service Addresses
Parameters
ob_enable 0x0 if the delivery service/identity should be disabled; otherwise, enable
ob_rj45 NIC Index the configuration applies to
ob_identity Identity the configuration applies to
ob_handle unused
ob_ipAddr if enabling, IP address for the delivery service/identity
ob_mask if enabling, net mask for the delivery service/identity
ob_token unused
ob_data unused
ob_bcast if enabling, broadcast IP address for the delivery service/identity
ob_info unused
   OB_CMD_RESOLVE_DNS Query a DNS Server for Name Resolution
   Parameters
ob_flags unused
ob_rj45 NIC Index
ob_identity unused—DNS requests always use ID 0 as the local address
ob_handle unused
ob_ipAddr IP address of DNS server (network byte order)
ob_gateAddr IP address of first hop (network byte order)
ob_length Length of DNS data (wire format)
ob_info 32-bit parameter to return
ob_data Address of wire-formatted DNS host name
   Description

In one embodiment, the action is to contact the specified DNS server to resolve the specified host name. The first hop IP address is guaranteed to be on the same subnet as the delivery service identity zero.

Results

When a DNS query is either complete or has failed, the connection portion of the connection block may be initialized as follows:
no_param May be set to the value of ob_info from the resolve command
no_status May be set to ENOERROR when the resolution is successful; otherwise, set to indicate how the request failed.
no_dsid May be set to the identity and system delivery service (not necessarily the same as the NIC index).
no_flags S64_NETOP_CONNECT|S64_NETOP_ACTIVE
no_endPoint May be set to the 64-bit equivalent value for the resolved IP address stored in an ipv4_endpoint structure.
   OB_CMD_ACCEPT Accept Incoming Connections
   Parameters
ob_protocol IP protocol (e.g., IPV4 _PROTO_TCP)
ob_rj45 NIC Index for new connections
ob_identity Identity for new connections
ob_handle unused
ob_ipAddr unused
ob_gateAddr unused
ob_length unused
ob_port TCP/UDP port (network byte order)
ob_token Application token to be returned with each new connection
   Description

In one embodiment, the action is to allow TCP to accept connections on the specified NIC/ID. Since the NIC and identity values uniquely determine the local IP address, it is not specified in the command block. The ob_token value is returned for each incoming connection. In one embodiment, if the protocol is UDP or ICMP, the command establishes a local endpoint to which remote machines may send UDP or ICMP packets, respectively.

Results

When a new connection is available, the connection portion of the connection block is initialized as follows:
no_param May be set to the value of ob_token from the accept command
no_status Will always be ENOERROR—there's not point in returning a result for a failed incoming connection
no_dsid May be set to the identity and system delivery service (not necessarily the same as the NIC index).
no_flags S64_NETOP_CONNECT|S64_NETOP_ACTIVE
no_endPoint May be set to the 64-bit equivalent value for the remote IP address and port stored in an ipv4_endpoint structure.
   OB_CMD_HANGUP Stop Accepting Incoming Connections
   Parameters
ob_protocol IP protocol (e.g., IPV4 _PROTO_TCP)
ob_rj45 NIC Index for connections
ob_identity Identity for connections
ob_handle unused
ob_ipAddr unused
ob_gateAddr unused
ob_length unused
ob_port TCP/UDP port (network byte order)
ob_param64 unused
   Description

In one embodiment, the action is to stop accepting incoming connections on the specified NIC/ID and port.

Results

NONE
   OB_CMD_CONNECT Connect to a Remote Address
   Parameters
ob_protocol IP protocol (e.g., IPV4 _PROTO_TCP)
ob_rj45 NIC Index for connection
ob_identity Identity for connection (local address)
ob_handle unused
ob_ipAddr IP address of remote machine (network byte order)
ob_gateAddr IP address of first hop (network byte order)
ob_length unused
ob_port TCP/UDP port (network byte order)
ob_token Application token to be returned when connection established
   Description

In one embodiment, the action is to connect to the specified remote machine. According to one embodiment, the first hop IP address is guaranteed to be on the same subnet as the specified delivery service.

In one embodiment, if the protocol is UDP, this command anchors a remote endpoint and all outbound packets are sent to the specified remote machine.

Results

When a new connection is available, the connection portion of the connection block is initialized as follows:
no_param May be set to the value of ob_token from the connect command
no_status May be set to indicate success (ENOERROR) or failure (other).
no_dsid May be set to the identity and system delivery service (not necessarily the same as the NIC index).
no_flags S64_NETOP_CONNECT|S64_NETOP_ACTIVE
no_endPoint May be set to the 64-bit equivalent value for the remote IP address and port stored in an ipv4_endpoint structure.
   OB_CMD_QUIESCE Wait for or Stop Pending Data Transfers
   Parameters
ob_reset If zero, the connection should close normally; otherwise, reset.
ob_rj45 unused
ob_identity unused
ob_handle Connection handle to quiesce
ob_ipAddr unused
ob_gateAddr unused
ob_length unused
ob_port unused
ob_token Application token to be returned when quiesce complete
   Description

In one embodiment, this command may be issued when the application closes a connection and there is a read and/or write command pending, or with pending results. The result value, when returned, allows the application to know that its data areas are no longer in use by the network. According to one embodiment, there are two sets of semantics, depending on whether ob_reset is zero (close) or non-zero (reset):

Close

Pending write (if any) may complete, with a normal result available. All data, including any pending write, may be delivered normally and a <FIN> sent at the end (see (3) for the exception)
Pending read (if any) may be stopped as soon as possible, and a normal result message may be delivered.
If the TCP/IP stack has not received a <FIN>, the connection may be reset. It follows that no effort will be made to deliver write data in this case. If a <FIN> was received and ACK'd, no reset may be issued, even if there is unread data.
   Reset
Pending write (if any) may terminate ASAP, and no result need be returned. Any pending write data may be discarded.
Pending read (if any) may terminate ASAP, and no result need be returned.
The TCP connection may be reset (<RST>).
   Note that after the quiesce result is delivered, the handle is still valid until the subsequent OB_CMD_CLOSE is received. It is up to OBTCP to remember whether the connection was closed or reset on the quiesce; the value of ob_reset in the close parameters must be ignored in this case.
   Results

When the data transfer(s) has completed or has been terminated, and the read and/or write result(s) have been queued (when ob_reset=0), the connection portion of the connection block may be set as follows:
no_param May be set to the value of ob_token from the quiesce command
no_status Always set to ENOERROR
no_dsid Unchanged
no_flags S64_NETOP_CONNECT|S64_NETOP_ACTIVE
no_endPoint Unchanged
   OB_CMD_CLOSE Close the Specified Connection
   Parameters
ob_reset If zero, the connection should close normally; otherwise, reset
ob_rj45 unused
ob_identity unused
ob_handle Connection handle to quiesce
ob_ipAddr unused
ob_gateAddr unused
ob_length unused
ob_port unused
ob_token unused
   Description

In one embodiment, the action is to tear down the connection and release its resources. See the description of OB_TCP_QUIESCE for the full semantics of ob_reset. Unlike other commands, no result is queued for the close.

Results

NONE
   OB_CMD_READ Initiate a Data Read
   Parameters
ob_flags unused
ob_rj45 unused
ob_identity unused
ob_handle Connection handle
ob_ipAddr unused
ob_gateAddr unused
ob_length Data transfer length
ob_info unused
ob_data Address of application buffer
   Description

In one embodiment, the action is to initiate a read on the specified connection of no more than ob_length bytes.

Results

According to one embodiment, when the read is completed, the read portion of the connection block is queued after setting as follows:
no_status May be set to ENOERROR if the read was successful, even if only part of the read request was satisfied. Otherwise, may be set to indicate the failure.
no_flags S64_NETOP_READ (one or more bytes transferred) S64_NETOP_READ|S64_NETOP_EOF (zero bytes transferred) S64_NETOP_READ|S64_NETOP_RESET (connection reset)
no_count May be set to the count of bytes transferred.
no_token For TCP, this value is zero. For UDP, this is set to the source IP and port using the same scheme as the connection no_endPoint.
   OB_CMD_WRITE Initiate a Data Write
   Parameters
ob_flags unused
ob_rj45 unused
ob_identity unused
ob_handle Connection handle
ob_ipAddr unused
ob_gateAddr unused
ob_length Data transfer length
ob_info unused
ob_data Address of application buffer
   Description

In one embodiment, the action is to initiate a write on the specified connection of ob_length bytes. Writes either succeed entirely or fail.

Results

When the write is completed, the write portion of the connection block is queued after setting as follows:
no_status May be set to ENOERROR if the read was successful, even if only part of the read request was satisfied. Otherwise, set to indicate the failure.
no_flags S64_NETOP_WRITE (if the connection is still available) S64_NETOP_WRITE|S64_NETOP_RESET (if the connection is reset)
   OB_CMD_SEND Initiate a Data Write with an Explicit Destination
   Parameters
ob_flags unused
ob_rj45 unused
ob_identity unused
ob_handle Connection handle
ob_ipAddr Destination IP address
ob_gateAddr First hop IP address
ob_length Data transfer length
ob_port UDP port
ob_data Address of application buffer
   Description

In one embodiment, the action is to initiate a write on the specified connection of ob_length bytes. The write will be set to the specified IP address and port, with ob_gateAddr as the first hop (may be the same as ob_ipAddr) Writes either succeed entirely or fail.

Results

When the write is completed, the write portion of the connection block is queued after setting as follows:
no_status May be set to ENOERROR if the read was successful, even if only part of the read request was satisfied. Otherwise, set to indicate the failure.
no_flags S64_NETOP_WRITE (if the connection is still available) S64_NETOP_WRITE|S64_NETOP_RESET (if the connection is reset)
   OB_CMD_PASS Transfer a Packet from One Connection to Another
   Parameters
ob_flags unused
ob_rj45 unused
ob_identity unused
ob_src Source (read) connection handle
ob_ipAddr Destination IP address
ob_dst Destination (write) connection handle
ob_length unused
ob_port unused
ob_data unused
   Description

In one embodiment, the action is to pass data directly from the read side of ob_src to the write side of ob_dst.

Results

When the transfer is completed, the write portion of the connection block is queued after setting as follows:
no_status May be set to ENOERROR if the read was successful, even if only part of the read request was satisfied. Otherwise, set to indicate the failure.
no_flags S64_NETOP_WRITE (if the connection is still available) S64_NETOP_WRITE|S64_NETOP_RESET (if the connection is reset)
   OB_CMD_EOF Mark the Connection as End-of-Data for Transmission
   Parameters
ob_flags unused
ob_rj45 unused
ob_identity unused
ob_handle Connection handle
ob_ipAddr unused
ob_gateAddr unused
ob_length unused
ob_port unused
ob_data unused
   Description

In one embodiment, the action is to mark the connection as end-of-data for the write side.

Results

NONE
   OB_CMD_CACHE Cache Dynamic Address Information
   Parameters
ob_flags unused
ob_rj45 NIC Index
ob_identity Always zero
ob_handle unused
ob_ipAddr IP Address
ob_gateAddr unused
ob_length unused
ob_port unused
ob_data unused
   Description

This command hints that the specified address is important, and that the OBTCP system should cache information, specifically the ARP translation. OBTCP is free to ignore this command.

Results

NONE

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An application programming interface (API) for a communication architecture, the API comprising:
a system abstraction representing a connection between a local machine and a remote machine, wherein connections instantiated by one or more applications based upon the system abstraction are capable of providing full duplex communication channels between their respective local machines and remote machines; and
a plurality of routines, accessible to the one or more applications, defining operations and associated parameters to establish, accept, read, write and close the connections.

2. The API of claim 1, wherein the operations are asynchronous and system code associated with the routines (i) validates the associated parameters, if any, (ii) queues the operations, and (ii) does not wait for completion before returning to a calling application.

3. The API of claim 1, wherein the plurality of routines allow a calling application to specify an arbitrary opaque parameter with each request that will be supplied with result status when the request is completed.

4. The API of claim 1, wherein read and write routines of the plurality of routines are able to accept and queue read and write requests, respectively, for a connection before the connection is fully established.

5. The API of claim 1, wherein a pass-thru routine of the plurality of routines provides the ability for data to be transferred directly from a first connection to a second connection without the data being accessed at the application-level.

6. The API of claim 1, wherein the API is implemented within a set of system services provided by a custom execution environment (CE²) that directly controls an underlying hardware platform.

7. The API of claim 1, wherein the API is implemented within a general purpose operating system.

8. The API of claim 1, wherein the API is implemented within a guest operating system context that provides and expands upon functionality of a typical virtual machine control program.

9. The API of claim 1, wherein the API facilitates scaling to multiple processors by implementing within the plurality of routines all locking necessary for a multiprocessing environment thereby safely queuing requests made of the plurality of routines.

10. The API of claim 1, further comprising a system abstraction representing a plurality of modular delivery services that transparently support both on-board and offload board implementations of associated drivers and network stacks.

11. The API of claim 1, wherein the plurality of routines make use of a shared request queue and a shared result queue.

12. The API of claim 1, wherein the API provides for modular addressing families for various protocols.

13. The API of claim 1, wherein the API provides modular delivery services for addressing families.

14. The API of claim 1, wherein the API is emulated on top of sockets.

15. A method of communicating data between a local machine and a remote machine, the method comprising:
an application executing within a custom execution environment (CE²) that controls the underlying hardware platform of the local machine establishing a full duplex communication channel with the remote machine using a first class connection abstraction provided by an asynchronous connection application programming interface (API) of the CE² and associating with the full duplex communication channel an opaque parameter;
before establishment of the full duplex communication channel has been completed, the application requesting data to be transferred from the local machine to the remote machine by invoking a write routine of the asynchronous connection API on the full duplex communication channel; and
the application subsequently receiving indications via the asynchronous connection API that the full duplex communication channel has been established and that the requested data transfer has been completed, and wherein both indications are accompanied by the opaque parameter.

16. The method of claim 15, wherein the asynchronous connection API facilitates scaling to multiple processors by implementing within routines associated with the asynchronous connection API all locking necessary for a multiprocessing environment thereby safely queuing multiple concurrent requests.

17. The method of claim 15, wherein the asynchronous connection API further provides an abstraction representing a plurality of modular delivery services that transparently support both on-board and offload board implementations of associated drivers and network stacks.

18. A method of communicating data between a local machine and a remote machine, the method comprising:
an asynchronous connection application programming interface (API) of a custom execution environment (CE²) that controls the underlying hardware platform of the local machine receiving a request from an application executing within the CE² to establish a full duplex communication channel with the remote machine using a first class connection abstraction provided by the asynchronous connection API, the request including an opaque parameter to be associated with the full duplex communication channel;
before establishment of the full duplex communication channel has been completed, the asynchronous connection API receiving from the application a write request specifying data to be transferred from the local machine to the remote machine;
responsive to the write request, the API queuing a request block associated with the write request pending completion of establishment of the full duplex communication channel;
after the full duplex communication channel has been established, the asynchronous connection API providing a first completion indication to the application, including the opaque parameter; and
after the write request has been processed, the asynchronous connection API providing a second completion indication to the application, including the opaque parameter.

19. The method of claim 18, wherein the asynchronous connection API facilitates scaling to multiple processors by implementing within routines associated with the asynchronous connection API all locking necessary for a multiprocessing environment thereby safely queuing multiple concurrent requests.

20. The method of claim 18, wherein the asynchronous connection API further provides an abstraction representing a plurality of modular delivery services that transparently support both on-board and offload board implementations of associated drivers and network stacks.
